(19) United States
(12) Patent Application Publication
(10) Pub. No.: US 2013/0219315 A1
(43) Pub. Date: Aug. 22, 2013

(54) Graphical User Interface for Real Estate Search

(71) Applicant: Harrison Gregory Hong, New York, NY (US)

(72) Inventor: Harrison Gregory Hong, New York, NY (US)

(21) Appl. No.: 13/400,068

(22) Filed: Feb. 18, 2012

(51) Int. Cl. G06F 3/048

(52) U.S. Cl. 715/771

(57) ABSTRACT

Some embodiments provide a method of providing a graphical user interface (GUI). The method provides a first user interface (UI) element for receiving a value that represents a budget price for a search of properties. The method provides a two-dimensional shape that includes several locations representing several property attributes. Each of at least two locations is associated with only one attribute and a remaining several locations are associated with more than one attribute. The method provides an indicator that is moveable within the two-dimensional shape for indicating a particular location within the two-dimensional shape. The particular location is for identifying several values that correlate the budget price to the several attributes. The method provides a second UI element that, when selected, initiates a search for properties based on the received value and the several values specified through the indicator.

### BACKGROUND

Today, a large number of real estate search tools offer the same or similar experience—a user of a real estate search tool specifies an area in which to search, a price range, a number of desired bedrooms, a number of desired bathrooms, a range of square footage, etc. The real estate search tools generally produce similar results.

In many cases, the number of search results is large and thus overwhelming to the user who is looking for a property to purchase and/or rent. So while the current real estate search tools may provide a plethora of search results, the tools are actually ineffective in reducing the search time for the user because the user is provided too many choices. Often the user will narrow the search query to reduce the number of search results, and may thus miss out on properties that are better matched to what the user is looking for.

### BRIEF SUMMARY

Some embodiments of the invention provide a novel system for defining a real estate model that is used to determine values (e.g., sale price, rental price, etc.) for properties. The real estate model of some embodiments is defined in terms of several components that specify the relationship between the value of a property and several of the property's attributes (e.g., a location attribute, a size attribute, a quality attribute, etc.). Thus, the value of a property is determined by several values that are each attributed to a corresponding attribute of the property.

In some embodiments, the system associates the price of a property to each of several different attributes of the property. The price in some embodiments is the listing or rental price of the property while in other embodiments the price is a price derived from the listing or rental price of the property. In some embodiments, the system uses a hedonic analysis to decompose the price of the property into several values that correspond to the several attributes of the property. One exemplary system of some embodiments computes and stores for the property a value for a location attribute, a value for a size attribute, and a value for a quality value based on the price of the property. In some embodiments, each of these computed and stored values is expressed in terms of a price, and the sum of these values equals the price of the property. Other embodiments, however, compute and/or stores different values. For example, some embodiments compute a price value for each of several different attributes, but then store a numerical value (e.g., a fraction) to express the association of each attribute to the price. Yet other embodiments do not even compute a component price value for each attribute, but rather simply computes a numerical value (e.g., a fraction) that associates each attribute to the price (e.g., that identifies each attribute's contribution to the price). Still other embodiments perform different forms of analysis, compute different and/or additional hedonic values, and/or analyze different property attributes.

The system of some embodiments is part of a search engine (e.g., a real estate search engine) that processes search queries for properties based on the property values determined by the system. A search query may specify a budget price and a distribution of the budget price across a set of property attributes. For instance, a search query might specify a budget price of $1,000 and a distribution of $500 to a quality attribute, $300 to a location attribute, and $200 to a size attribute. The real estate search engine of some embodiments processes search queries by (1) identifying properties that have determined values that are the same or similar the budget price and (2) ranking the identified properties based on the attribute values of the properties. In some embodiments, the real estate search engine ranks properties with determined attribute values that closely match the attribute values specified in the search query higher than properties with determined attribute values that less closely match the attribute values specified in the search query.

The search engine of some embodiments provides a novel tool that (1) allows a user to easily express the importance of the different attributes of the property, (2) converts this expression into several values that express the different contributions of the different attributes to the price, and (3) uses these different values to formulate the search query. For instance, in some embodiments, the novel tool has a user interface that includes a geometric shape and a slider that slides along this shape. Various locations on the geometric shape are associated with the different attributes of the property. One example of such a geometric shape is a polygonal shape (e.g., a triangle or a parallelogram) and one example of such locations includes the vertices of a polygonal shape. In such an example, the slider of some embodiments is defined to be a moveable control that is initially placed at an equidistant location to the vertices of the shape. By moving the slider within the shape, the user can intuitively specify the different relative importance of the difference attributes to the user.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a real estate value determination system of some embodiments.

FIG. 2 conceptually illustrates a process of some embodiments for processing real estate data.

FIG. 3 conceptually illustrates the input and output of a real estate data processor of some embodiments.

FIG. 4 conceptually illustrates a software architecture of a real estate data processor of some embodiments.

FIG. 5 conceptually illustrates a process of some embodiments for verifying real estate location data.

FIG. 6 conceptually illustrates a data structure for a property according to some embodiments of the invention.

FIG. 7 conceptually illustrates the input and output of a real estate modeler of some embodiments.

FIG. 8 conceptually illustrates a software architecture of a real estate modeler of some embodiments.

FIG. 9 conceptually illustrates a process of some embodiments for generating a real estate model.

FIG. 10 conceptually illustrates the input and output of a real estate value evaluator of some embodiments.

FIG. 11 conceptually illustrates a software architecture of a real estate value evaluator of some embodiments.

FIG. 12 conceptually illustrates a process of some embodiments for evaluating a value for a property.

FIG. 13 conceptually illustrates a data structure for an evaluated property according to some embodiments of the invention.

FIG. 14 conceptually illustrates the input and output of a real estate search engine of some embodiments.

FIG. 15 conceptually illustrates a process of some embodiments for processing a real estate search query.

FIGS. 16-18 conceptually illustrate example graphical user interfaces (GUIs) for creating a search query for property.

FIG. 19 conceptually illustrates attribute weights based on an example position of the attribute weight selector of some embodiments.

FIG. 20 conceptually illustrates a software architecture of a real estate search engine of some embodiments.

FIG. 21 conceptually illustrates a process of some embodiments for determining attribute weights for properties.

FIG. 22 conceptually illustrates an example GUI that shows results of a real estate search query.

FIG. 23 conceptually illustrates a software architecture of a real estate search system of some embodiments.

FIG. 24 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a novel system for defining a real estate model that is used to determine values (e.g., sale price, rental price, etc.) for properties. The real estate model of some embodiments is defined in terms of several components that specify the relationship between the value of a property and several of the property's attributes (e.g., a location attribute, a size attribute, a quality attribute, etc.). Thus, the value of a property is determined by several values that are each attributed to a corresponding attribute of the property.

In some embodiments, the system associates the price of a property to each of several different attributes of the property. The price in some embodiments is the listing or rental price of the property while in other embodiments the price is a price derived from the listing or rental price of the property. In some embodiments, the system uses a hedonic analysis to decompose the price of the property into several values that correspond to the several attributes of the property. One exemplary system of some embodiments computes and stores for the property a value for a location attribute, a value for a size attribute, and a value for a quality value based on the price of the property. In some embodiments, each of these computed and stored values is expressed in terms of a price, and the sum of these values equals the price of the property. Other embodiments, however, compute and/or stores different values. For example, some embodiments compute a price value for each of several different attributes, but then store a numerical value (e.g., a fraction) to express the association of each attribute to the price. Yet other embodiments do not even compute a component price value for each attribute, but rather simply computes a numerical value (e.g., a fraction) that associates each attribute to the price (e.g., that identifies each attribute's contribution to the price). Still other embodiments perform different forms of analysis, compute different and/or additional hedonic values, and/or analyze different property attributes.

The system of some embodiments is part of a search engine (e.g., a real estate search engine) that processes search queries for properties based on the property values determined by the system. A search query may specify a budget price and a distribution of the budget price across a set of property attributes. For instance, a search query might specify a budget price of $1,000 and a distribution of $500 to a quality attribute, $300 to a location attribute, and $200 to a size attribute. The real estate search engine of some embodiments processes search queries by (1) identifying properties that have determined values that are the same or similar the budget price and (2) ranking the identified properties based on the attribute values of the properties. In some embodiments, the real estate search engine ranks properties with determined attribute values that closely match the attribute values specified in the search query higher than properties with determined attribute values that match less closely the attribute values specified in the search query.

The search engine of some embodiments provides a novel tool that (1) allows a user to easily express the importance of the different attributes of the property, (2) converts this expression into several values that express the different contributions of the different attributes to the price, and (3) uses these different values to formulate the search query. For instance, in some embodiments, the novel tool has a user interface that includes a geometric shape and a slider that slides along this shape. Various locations on the geometric shape are associated with the different attributes of the property. One example of such a geometric shape is a polygonal shape (e.g., a triangle or a parallelogram) and one example of such locations includes the vertices of a polygonal shape. In such an example, the slider of some embodiments is defined to be a moveable control that is initially placed at an equidistant location to the vertices of the shape. By moving the slider within the shape, the user can intuitively specify the different relative importance of the difference attributes to the user.

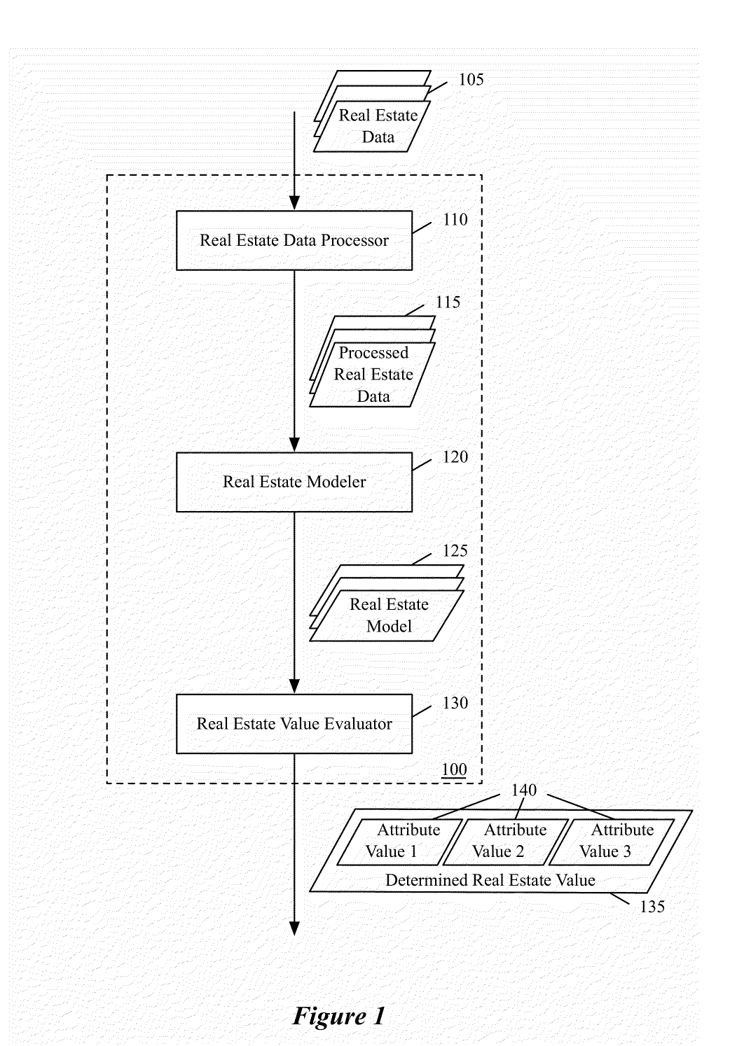

FIG. 1 conceptually illustrates a real estate value determination system 100 of some embodiments. As shown, the real estate value determination system 100 includes a real estate data processor 110, a real estate modeler 120, and a real estate value evaluator 130.

As illustrated in FIG. 1, the system 100 receives real estate data 105 at the real estate data processor 110. The real estate data 105 may include any number of different types of data related to real estate. For instance, the real estate data 105 may include data about the location of the properties, the number of units in the property, the size of the property, the sale or rental price of the property, etc. In addition, the real estate data 105 may be obtained from a variety of different sources. For example, the real estate data processor 110 may gather the real estate data 105 from real estate websites, public real estate records, sale and/or rental listings, geocoding tools, etc.

When the real estate data processor 110 receives the real estate data 105, the real estate data processor 110 performs various operations to the real estate data 105. In some embodiments, the real estate data processor 110 modifies and organizes the real estate data 105 according to a defined format, analyzes the real estate data 105 to verify that the real estate data 105 is reliable and/or accurate, and filters the real estate data 105 to identify the desired data from the real estate data 105. Different embodiments may include additional and/or different operations to process the real estate data 105. In some embodiments, the real estate data processor 110 performs the data processing operations based on a defined set of rules. When the real estate data processor 110 completes processing of the real estate data 105, the real estate data processor 110 outputs processed real estate data 115 to the real estate modeler 120.

The real estate modeler 120 uses the processed real estate data 115 to define a set of real estate models 125. In some embodiments, a real estate model is a tool that is used to determine a value of a property based on a set of attributes of the property. The real estate model of some embodiments specifies a relationship between the value of a property and a set of attributes of the property. In different embodiments, the real estate modeler 120 defines any number of different real estate models 125 that may be used separately or together to determine a value of a property.

In some embodiments, the real estate modeler 120 defines a real estate model by performing regression analysis on the processed real estate data 115 to build a regression model of property value on several property attributes. In conjunction with regression analysis, the real estate modeler 120 of some embodiments uses hedonic analysis on the processed real estate data 115 to build a hedonic regression model that specifies a set of relationships between property values and a set of property attributes. For instance, the hedonic regression model of some embodiments specifies a relationship between the values of properties and the properties' quality attribute, a relationship between the values of properties and the properties' location attribute, and a relationship between the values of properties and the properties' size attribute. The real estate modeler 120 of some embodiments may use additional and/or different techniques for defining one or more real estate models. When the real estate modeler 120 has completed defining the set of real estate models 125, the real estate modeler 120 outputs the set of real estate models 125 to the real estate value evaluator 130.

When the real estate value evaluator 130 receives the set of real estate models 130, the real estate value evaluator 130 uses the set of real estate models 130 to determine values for properties. To determine a value for a property, the real estate value evaluator 130 identifies a set of attributes of the property and uses the set of real estate models 125 to determine a value for each attribute in the set of attributes.

For example, in some embodiments where the real estate modeler 120 defines a hedonic regression model that specifies a set of relationships between property values and a set of property attributes, the real estate value evaluator 130 uses the set of relationships to determine a value for each property attribute (e.g., values for a property's quality attribute, location attribute, and size attribute). The determined value for the property is the total of the determined values for the attributes of the property. In other words, the real estate value evaluator 130 decomposes the property into a set of attributes and determines a value for each attribute in the set of attributes of the property in order to determine the total value of the property. In this manner, a value of a property is determined based on a set of attributes of the property. As shown in FIG. 1, the real estate value evaluator 130 outputs a determined real estate value 135 for a property. The determined real estate value 135 includes several attribute values 140. Each attribute value 140 is the determined value for a corresponding attribute of the property.

In some embodiments, the real estate value evaluator 130 is used to determine values for multiple different properties. For instance, in some cases, the real estate value evaluator 130 determines the values of the properties associated with the data 105 that the real estate data processor 110 processed and the real estate modeler 120, in turn, used to define a real estate model. The real estate value evaluator 130 may determine values of other properties as well. For example, the real estate value evaluator 130 may determine values of properties in the same or similar area of the properties associated with the data 105.

As mentioned above, the system of some embodiments is part of a search engine (e.g., a real estate search engine). In some such embodiments, the a search engine uses the values determined by the system 100 in order to process search queries for properties based on the determined property values.

While the examples and embodiments in this application describe apartment buildings, one of ordinary skill in the art will realize that the examples and embodiments may be applicable to additional and/or other types of property. For example, the techniques described in this application may be applicable to houses, condos, apartments (e.g., individual apartments in an apartment building), hotel rooms, office buildings, etc.

Several more detailed embodiments of the invention are described in the sections below. Section I conceptually describes details of obtaining real estate data and processing the real estate data according to some embodiments of the invention. Next, Section II conceptually describes details of defining a real estate model of some embodiments and using the real estate model to determine values of properties. Section III follows this with a description of a real estate search engine that searches on real estate that have been valued using a real estate model of some embodiments. Next, Section IV describes the software architecture of a real estate search system of some embodiments. Finally, Section V describes an electronic system that implements some embodiments of the invention.

### I. Real Estate Data Processing

As described above, the system of some embodiments processes real estate data in order to define a set of real estate models. In some embodiments, the system then uses to defined set of real estate models to determine values for properties.

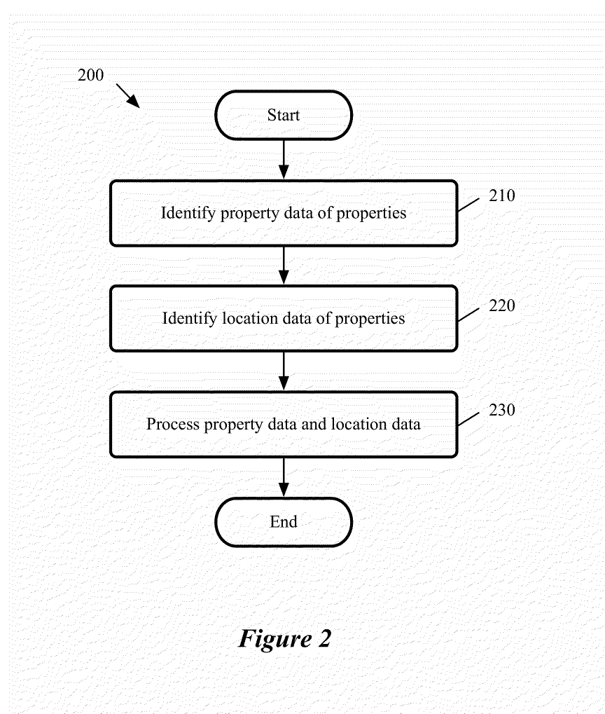

FIG. 2 conceptually illustrates a process 200 of some embodiments for processing real estate data. In some embodiments, the process 200 is performed by a real estate data processor, such as the one described above by reference to FIG. 1.

The process 200 starts by identifying (at 210) property data of properties. In some embodiments, the process 200 identifies the property data of properties by accessing defined sources of property data. Sources of property data may include real estate websites, public real estate records, sale and/or rental listings, or any other type of source that has data related to properties. The process 200 of some such embodiments then retrieves the property data available at the defined sources.

Next, the process 200 identifies (at 220) location data of properties. The process 200 of some embodiments identifies the location data of each property for which property data is identified by the process 200. In some embodiments, the location data specifies the geographical location of the property. The location data of different embodiments may be expressed in different geographic coordinate systems. Examples of geographic coordinate systems include a latitude and longitude coordinate system, a Universal Transverse Mercator (UTM) coordinate system, a Universal Polar Stereographic (UPS) coordinate system, a Cartesian coordinate system, etc.

In some embodiments, the process 200 uses a third party geocoding tool (e.g., Google Maps® application programming interface (API), Yahoo Maps! ® API, etc.) in order to identify location data for properties. In some cases, the third party geocoding tool provides the location data in an undesirable or incompatible coordinate system. In such cases, the process 200 converts the coordinate system of the location data provided by the third party tool to a desirable or compatible coordinate system.

Finally, the process 200 processes (at 230) the property data and the location data of the properties. As mentioned above, different embodiments process real estate data using any number of different operations. For instance, the process 200 of some embodiments may modify the property data and the location data to a defined format. Another example operation that the process 200 may perform on the property data and the location data includes examining the data to verify the data for reliability and/or accuracy. In some instances, the process 200 may not need every part of the data that is identified. In these instances, the process 200 may filter the property data and the location data to identify only the desired data. The process 200 may perform additional and/or other operations in order to process the property data and the location data in other embodiments.

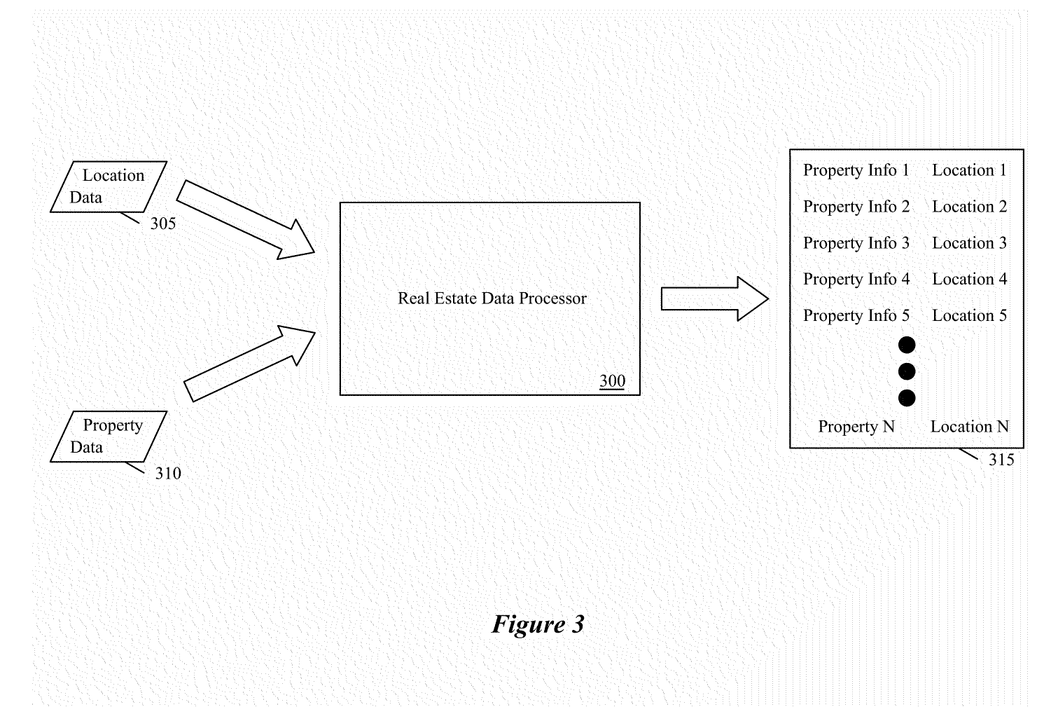

FIG. 3 conceptually illustrates the input and output of a real estate data processor 300 of some embodiments. As shown, location data 305 and property data 310 are input to the real estate data processor 300. In some embodiments, the location data 305 includes the location of each property described by the property data 310. The real estate data processor 300 performs several operations (e.g., formatting, verifying, filtering, etc.) on the property data 310 and the location 305. After processing the data 305 and 310, the real estate data processor 300 outputs the processed data 315. As shown in FIG. 3, the processed data 315 includes the property data of N properties and the corresponding location data of each of the N properties.

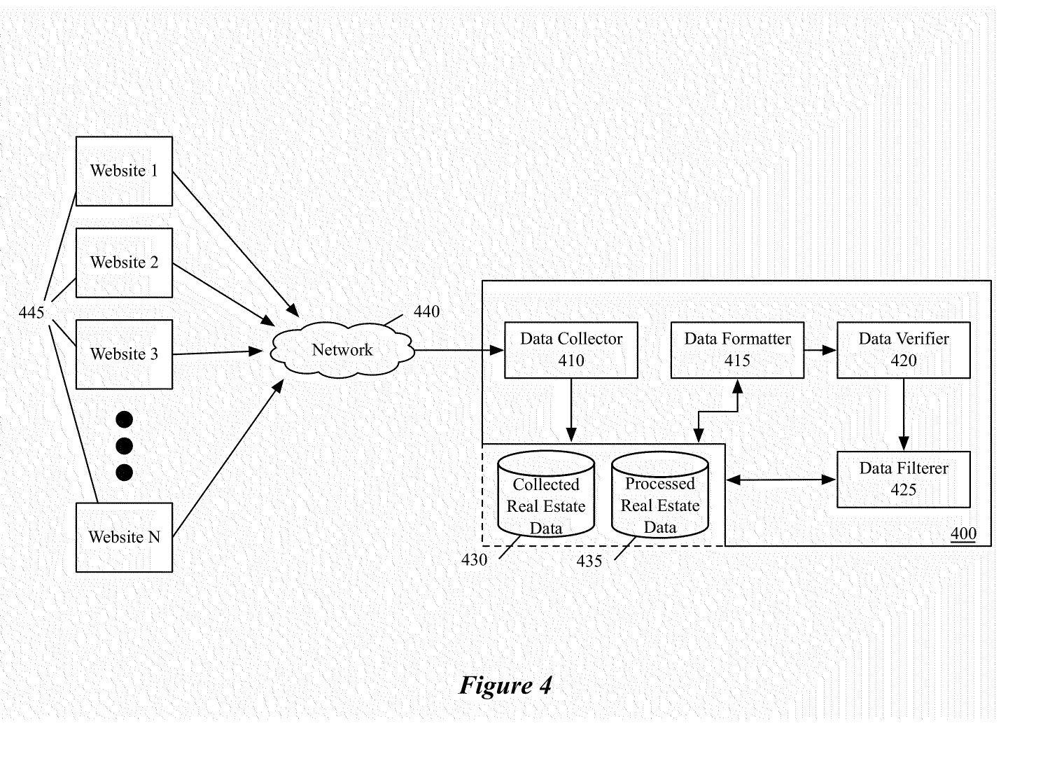

FIG. 4 conceptually illustrates a software architecture of a real estate data processor 400 of some embodiments. In some embodiments, the real estate data processor 400 is a module that receives property data of properties and location data of properties, and outputs processed property data and location data, as illustrated in FIG. 3. The real estate data processor 400 of some embodiments performs the process 200, which is described above by reference to FIG. 2, to process real estate data.

As shown, the real estate data processor 400 includes a data collector 410, a data formatter 415, a data verifier 420, and a data filterer 425. FIG. 4 also illustrates a collected real estate data storage 430 and a processed real estate data storage 435. In some embodiments, the data storages 430 and 435 are implemented as one physical storage. In other embodiments, the collected real estate data and the processed real estate data are stored in separate physical storages.

The data collector 410 retrieves real estate data from sources of real estate data. In this example, the data collector 410 retrieves real estate data from websites 445 over a network 440. The websites may include any type of website that contains real estate data or data related to real estate. Example of such websites include real estate websites, websites that provide public real estate records, sales/rental listing websites, websites that provide geocoding tools, etc. The network 440 may be the Internet, a local network, a wide area network, a network of networks, or any other type of network. In some embodiments, the data collector 410 utilizes a crawling tool to crawl the websites 445 for the real estate data. When the data collector 410 receives the real estate data from the websites 445, the data collector 410 stores the received data in the collected real estate data storage 430. In some embodiments, the data collector 410 retrieves data from the real estate data sources at defined intervals (e.g., every hour, once a day, once a week, etc.) in order to establish a history of real estate data and to obtain the current real estate data.

In some embodiments, the data formatter 415 formats real estate data stored in the collected real estate data storage 430 according to a defined format. To format the real estate data, the data formatter 415 of some embodiments modifies and organizes the data based on a set of formatting rules. In some such embodiments, the rules are stored in one of the storages 430 or 435. For instance, the data formatter 415 may expand abbreviations contained in the data, remove articles (e.g., “the”, “a”, “an”, etc.) and/or white space from the data, reorder the data etc.

As noted above, the location data of different embodiments may be expressed in different geographic coordinate systems. Hence, for location data, the data formatter 415 may convert the coordinate system of the location data collected from the websites 445 to another coordinate system that is compatible with the data formatter 415. In some embodiments, the data collector 410 performs the coordinate system conversion instead of the data formatter 415.

The data verifier 420 receives the real estate data from the data formatter 415 and verifies the data. The data verifier 420 verifies the real estate data in order to ensure that the data is reliable and/or accurate. In some embodiments, the data verifier 420 checks for reliability and accuracy of the data by comparing real estate data against a second source. For instance, the real estate data of a particular property retrieved from a website 445 is compared to real estate data of the particular property that is retrieved from another website 445 or another real estate source. If the number of differences between the real estate data from the different sources does not pass a threshold number, the data verifier 420 determines that the real estate data for the particular property is reliable and accurate. Additional and/or other techniques for determining reliability and/or accuracy of the real estate data may be utilized in other embodiments.

The data filterer 425 is responsible for filtering the real estate data that the data filterer 425 receives from the data verifier 425. In some instances, the real estate data processor 400 does not need all the real estate data that is collected from the websites 445. Therefore, the data filterer 425 filters through the real estate data and identifies the data that the real estate data processor 400 needs. The data filterer 425 of some embodiments filters the real estate data based on a defined set of filtering rules. After the data filterer 425 filters the real estate date, the data filterer 425 stores the data in the processed real estate data storage 435.

The operation of the real estate data processor 400 will now be described. The data collector 410 retrieves real estate data from the websites 445 over the network 440. The data collector 410 stores the retrieves real estate data in the collected real estate data storage 430 for later processing.

After the real estate data is stored, the data formatter 415 retrieves the real estate data from the collected real estate data storage 430 to format the data. The data formatter 415 performs various formatting operations to modify and/or organize the real estate data. In some embodiments, the data formatter 415 formats the data based on a set of formatting rules. Once the data formatter 415 formats the real estate data, the data formatter 415 sends the data to the data verifier 420.

When the data verifier 420 receives the formatted real estate data from the data formatter 415, the data verifier 420 determines the reliability and/or accuracy of the data. The data verifier 420 of some embodiments verifies the real estate data by comparing it to real estate data provided by a second source. When the data verifier 420 determines that the real estate data is not reliable or accurate, the data verifier 420 discards the data. When the data verifier 420 determines that the real estate data is reliable and/or accurate, the data verifier 420 sends the data to the data filterer 425.

The data filterer 425 receives the formatted and verified real estate data from the data verifier 420 and filters the data. As the real estate data may include unwanted data, the data filterer 425 of some embodiments uses a defined set of filtering rules to identify desired data and discard undesired data. After filtering the real estate data, the data filterer 425 stores the data in the processed real estate data storage 435.

FIG. 4 illustrates a particular order of processing of real estate data—the data is formatted, verified, and then filtered. However, one of ordinary skill in the art will recognize that the modules may act on the real estate data in different orders in different embodiments. For example, in some embodiments, the data verifier 420 retrieves the real estate data from the collected real estate data storage 430 to verify the data and then passes the verified data to the data formatter 415 for formatting. After the data formatter 415 finishes formatting the data, the data formatter 415 passes the real estate data to the data filterer 425 for filtering.

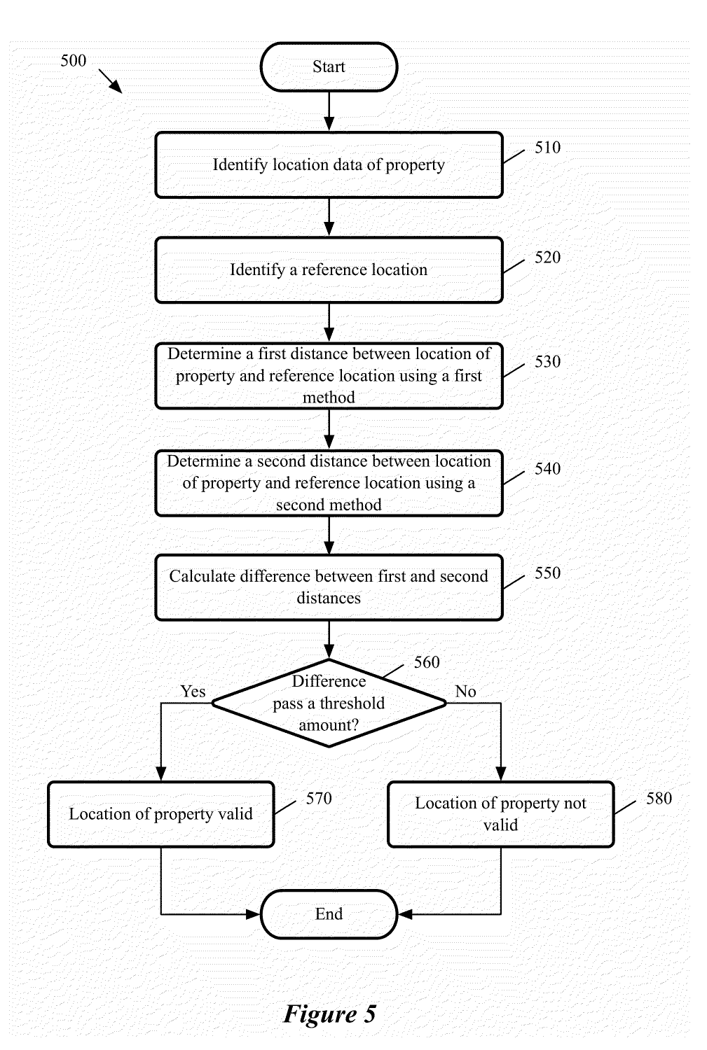

FIG. 5 conceptually illustrates a process 500 of some embodiments for verifying real estate location data. The process 500 is performed to verify the location data of one property. As such, the process 500 is iteratively performed for each property that is to be verified. In some embodiments, the process 500 is performed by a real estate data processor such as the ones described above and below by reference to FIGS. 1, 3, 4, and 23. For example, the data verifier of the real estate data processor described above by reference to FIG. 4 performs the process 500 in some embodiments.

The process begins by identifying (at 510) the location data of a property. As described above, the location data specifies the geographical location of a property and is expressed in terms of a geographic coordinate system. In some embodiments, the process 500 converts the coordinate system of the location data to a defined coordinate system. In this example, the process 500 converts the coordinate system of the location data to a latitude and longitude coordinate system.

Next, the process 500 identifies (at 520) a reference location. The reference location may be defined as any location other than the location of the property. The process 500 of some embodiments converts the coordinate system of the reference location to the coordinate system of the location data. That is, the process 500 normalizes the location data of the property and the location data of the reference location. For this example, the process 500 converts the coordinate system of the reference location to a latitude and longitude coordinate system.

The process 500 then determines (at 530) a first distance between the location of the property and the reference location using a first method. Any number of different methods may be used to determine the distance between the location of the property and the reference location.

In this example, the first method that is used to determine the distance between the location of the property and the reference location is based on a third party geocoding tool. As such, the process 500 inputs the location of the property and the reference location to the geocoding tool and the process 500 retrieves the distance output by the geocoding tool.

After determining the distance using a first method, the process 500 determines (at 540) a second distance between the location of the property and the reference location using a second method. As noted above, any number of different methods may be used to determine the distance between the location of the property and the reference location. The second distance is determined using a method different than the first method that is used to determine the first distance in some embodiments. In this example, the second method that is used to determine the distance between the location of the property and the reference location is a mathematical equation for calculating the distance between two points. As mentioned above, the location data of the property and the reference location are both expressed in terms of a latitude and longitude coordinate system in some embodiments. Therefore, the following equation (1) is used to determine the second distance in some such embodiments:

d=6371.004 arc cos(cos φA cos φB+sin φA sin φB cos(λB−λA))

where φA is 90 degree minus/plus the latitude for point A in northern/southern hemisphere, λA is the longitude for point A, φB is 90 degree minus/plus the latitude for point B in northern/southern hemisphere, λB is the longitude for point B, and d is the distance between point A and point B in terms of kilometers.

Next, the process 500 calculates (at 550) the difference between the first and second distances. In some cases, the process 500 may convert one or both distances so that the first and second distances are expressed in terms of the same units. The process 500 of some embodiments calculates the absolute difference between the first and second distances.

At 560, the process 500 determines whether the difference between the first and second distances passes a threshold amount. In other words, the process 500 compares the first and second distances to determine the similarity between the first and second distances. In some embodiments, the threshold amount is a defined distance mount. In other embodiments, the threshold amount is an amount based on a percentage of the first or second distance. When the process 500 determines that the difference does not pass the threshold amount, the process 500 determines (at 570) that the location data of the property is valid and then the process 500 ends. On the other hand, when the process 500 determines that the difference does pass the threshold amount, the process 500 determines (at 580) that the location data of the property is not valid and then ends.

The above section describes a real estate data processor of some embodiments that receives property data for properties and location data of the properties described by the property data. The real estate data processor performs numerous operations to process the property data and the location data. In some embodiments, the real estate data processor generates and stores a data structure to represent the information.

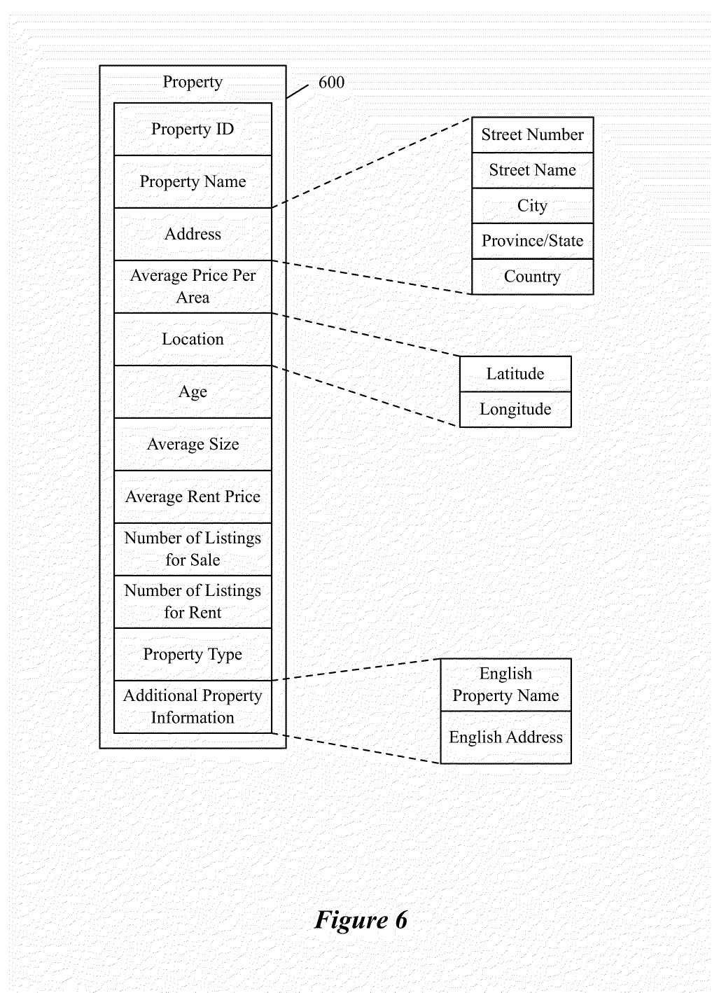

FIG. 6 conceptually illustrates a data structure 600 for a property according to some embodiments of the invention. In some embodiments, a real estate data processor (e.g., the real estate data processors described above and below by reference to FIGS. 1, 3, 4, and 23) creates and stores the data structures 600 when the real estate data processor has completed processing the real estate data For this example, the data structure 600 stores data that represents an apartment building (e.g., a property that includes several apartments).

As illustrated in FIG. 6, the data structure 600 includes a property identifier (ID) field, a property name field, an address field, an average price per area field, a location field, an age field, an average size field, an average rent price field, a number of listings for sale field, a number of listings for rent field, a property type field, and an additional information field. The property ID is a unique identifier (e.g., a unique integer) for identifying a particular property. The property name field represents the name of the property. As shown, the address field of the data structure 600 includes a street number field, a street name field, a city field, a province/state field, and a country field. The average price per area field of some embodiments represents the average price per square meter. In some cases, the average price per area field of some embodiments represents the average price per square feet. Other units may be used as well (e.g., square inches, square centimeters, etc.).

As described above, the location data of some embodiments is expressed in terms of a geographic coordinate system. In this example, a latitude and longitude coordinate system is used to express the location of the property (e.g., in terms of degrees and fractions of degrees; or degrees, minutes, and seconds). The age field of the data structure 600 represents the age of the property (e.g., months, years, decades, etc.). The average size field represents the average size of the apartments in the property. The average rent price field represents the average price for which the apartments in the apartment building are rented. The number of listings for sale field is the number of apartments in the apartment building that are currently listed for sale and the number of listings for rent field is the number of apartments that are currently listed for rent.

The property type field represents the type of property that the data structure 600 represents. As mentioned above, for this example, the data structure 600 represents an apartment building. However, the same or similar data structure may represent a house, a hotel, a condo, an office building, etc. As the data structure 600 can represent a property located anywhere in the world, in some embodiments, the name and address field of the data structure 600 is stored in one language (e.g., the local language of the property). Thus, as shown in FIG. 6, the data structure 600 of some embodiments stores the name and address equivalent in another language. For this example, the additional information filed includes an English property name field that represents the English equivalent of the property name and the English address field represents the English equivalent of the address.

As described above, FIG. 6 illustrates an example data structures for representing an apartment building. One of ordinary skill in the art will realize that the data structure of may include additional and/or different fields. For instance, a data structure that represents a house does not include a number of listings for sale field, an average rent price field, etc.

### II. Defining a Real Estate Model

As explained above, after the system receives and processes real estate data, the system of some embodiments uses the processed real estate data to define a set of real estate models. The following section will describe examples and details of embodiments for defining a real estate model. As mentioned above, in some embodiments, the real estate model is defined in terms of several components that model several corresponding property attributes. The examples in this section describe defining a real estate model based on three property attributes: (1) a location attribute, (2) a size attribute, and (3) a quality attribute. One of ordinary skill in the art will recognize that different real estate models may be defined based on additional and/or different property attributes.

A. Defining a Real Estate Model

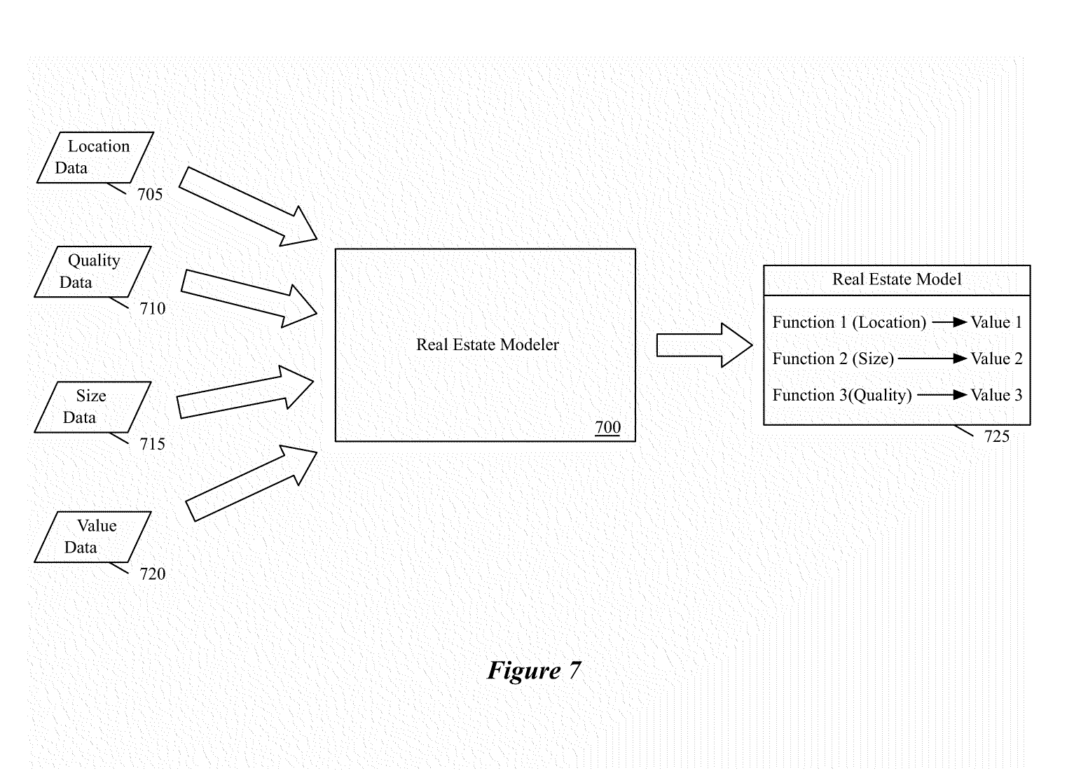

FIG. 7 conceptually illustrates the input and output of a real estate modeler 700 of some embodiments. As illustrated in FIG. 7, location data 705, quality data 710, size data 715, and value data 720 are input to the real estate modeler 700. In some embodiments, the real estate modeler 700 performs regression analysis on the location data 705, quality data 710, size data 715, and value data 720 to define a real estate model 725 that determines the value of a property based on the location of the property, the quality of the property, and the size of the property. As shown, the real estate modeler 700 outputs the real estate model 725, which is expressed in terms of functions 1-3. Each function determines a value of a property for a property attribute based on the property attribute of the property. The sum of the values is the total value of the property. That is, each function models a relationship between a property attribute of a property and the value of the property.

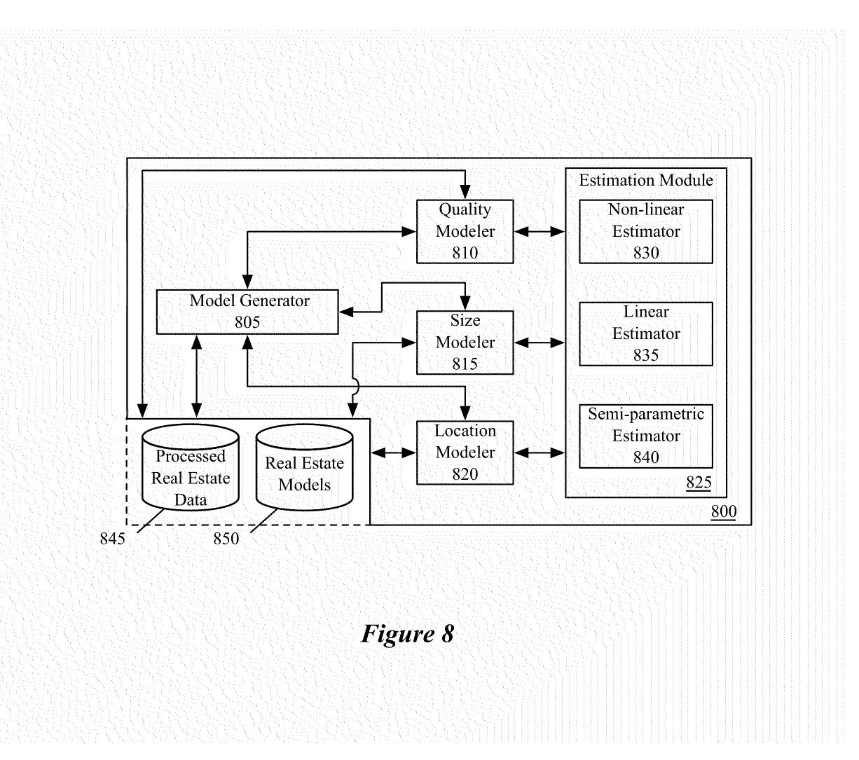

FIG. 8 conceptually illustrates a software architecture of a real estate modeler 800 of some embodiments. In some embodiments, the real estate modeler 800 is a module that receives location data, quality data, size data, and value data, and outputs a real estate model, as illustrated in FIG. 7. As shown, the real estate modeler 800 includes a model generator 805, a quality modeler 810, a size modeler 815, a location modeler 820, and an estimation module 825. In addition, FIG. 8 illustrates a processed real estate data storage 845 and a real estate models storage 850. In some embodiments, the data storages 845 and 850 are implemented as one physical storage. In other embodiments, the processed real estate data and the real estate models are stored in separate physical storages. The processed real estate data storage 845 is similar the processed real estate data storage described above by reference to FIG. 4 but includes additional data, which is described in more detail below. Some portions of the additional data are manually provided while other portions of the additional data are automatically retrieved (e.g., by the data collector described by reference to FIG. 4).

The model generator 805 handles the generation of real estate models. In some embodiments, the model generator 805 uses the modelers 810-820 to define a real estate model for determining a value of a property based on a set of attributes of the property. To generate a real estate model, the model generator 805 of some embodiments identifies the real estate data in the processed real estate data storage 845 for each of the modelers 810-820 to use to model the value of a particular property attribute.

In some embodiments, the model generator 805 generates a real estate model for each type of property value. For instance, in some such embodiments, the model generator 805 generates a real estate model for determining a rental value of a property based on a set of attributes of the property and generates another real estate model for determining a sale value of a property based on the set of attributes of the property. Moreover, the model generator 805 of some embodiments may also generate a real estate model for each combination property attributes. For example, the model generator 805 in some of these embodiments might generate a real estate model for determining a rental value of a property based on a location attribute, size attribute, and quality attribute of the property and generates another real estate model for determining a rental value of a property based on the set of attributes of the property. As such, the model generator 805 can generate any number of real estate models for any number of different combinations of property value types and property attributes.

After the model generator 805 receives the models from the modelers 810-820, the model generator 805 defines a real estate model for determining a value of a property based on a set of attributes of the property and stores the real estate model in the real estate models storage 850. In this example, the model generator 805 defines a real estate model for determining a value of a property based on a location attribute, size attribute, and quality attribute of the property.

As noted above, the data collector of some embodiments retrieves data from real estate data sources at defined intervals (e.g., every hour, once a day, once a week, etc.). To account for changes in the real estate data and to keep the real estate model current, the model generator 805 of some embodiments defines a new real estate model at defined intervals (e.g., once a day, once a week, once a month, twice a year, etc.). In addition, the model generator 805 may define real estate models based on a defined sample of data. For instance, in some embodiments, the model generator 805 defines real estate models based on the real estate data from a defined timer interval (e.g., real estate data from the past 1 month, 6 months, 1 year, 3 years, etc.), real estate data of properties within a defined geographical area (e.g., real estate data of properties within a radius of a particular location).

The quality modeler 810 is responsible for determining a relationship between values of properties and the quality of the properties. In some embodiments, the quality modeler 810 uses numerous different types of data that represent, indicate, and/or affect the quality of a property in determining the relationship. As such, the additional data stored in the processed real estate data storage 845 of some embodiments includes data for assessing the quality of a property (also referred to as quality variables). Examples of quality variables include capital gains and/or losses of the property, whether the property qualifies for attendance to particular schools in the area, the rank of the schools, the reputation of the construction company that constructed the property, locations of environmentally unsound and/or unsafe areas, the liquidity of the property, user feedback (e.g., posted on websites) about the property, investment value of the property, etc.

In some embodiments, the quality modeler 810 quantifies some or all of the quality variables. For instance, capital gains and losses of some embodiments is quantified based on the average prices of the property (e.g., average prices of apartments in an apartment building) for the past N years and predicted prices of the property for the past N years. In some embodiments, N is a predefined integer. Whether the property qualifies for particular schools in the area, the rank of the schools, and the reputation of the construction company that constructed the property are each quantified based on information obtained from websites, information obtained from people local to the area of the property, or a combination of the two.

The location of environmentally unsound and/or unsafe areas may be quantified as the number of such locations within a defined distance from the location of the property, the average distance of such locations to the location of the property, the sum of the distances from such locations to the location of the property, or any combination of such values. Additional and/or different techniques may be used to quantify location of environmentally unsound and/or unsafe areas in different embodiments. As another example, the investment value of the property of some embodiments is based on the difference between the sale price of the property and the sale price of other similar properties, the predicted rate of appreciation of property in the area, the current mortgage interest rate, etc. In some embodiments, the liquidity of an apartment building is quantified as the number of apartment listings (e.g., rental, sales, or both).

In some instance, the user feedback about a property is in the form of score values. In such cases, the quality modeler 810 uses the score values to represent this quality variable. In other instances, the user feedback about the property is in the form of comments that users have provided. In these cases, the quality modeler 810 of some embodiments quantifies the user feedback by using semantic analysis to count the number of words defined as “good” words, count the number of words defined as “bad” words, and determine a ratio of good words to bad words. Other semantic analysis techniques may be used to quantify the user feedback.

In addition to quantifying the different quality variables, the quality modeler 810 of some embodiments assigns weights to the quality variables. In this manner, certain quality variables can be specified as having a greater influence in the determination of the quality of a property compared to other quality variables.

To determine a relationship between the values of properties and the quality of the properties, the quality modeler 810 performs a regression analysis on the quality variables of the properties and the values of the properties. In some embodiments, the quality variables used for the regression analysis are the current quality variables. However, in some cases, the quality variables used for the regression analysis also include past quality variables (e.g., the quality variables from the past month, the quality variables from the past 6 months, the quality variables from the past year, etc.). The quality modeler 810 of some embodiments performs the regression analysis on the data by using the estimation module 825 to determine a relationship between the values of properties and the quality of the properties.

The size modeler 815 determines a relationship between values of properties and the sizes of the properties. In some embodiments, the size modeler 815 performs a regression analysis on the size of properties and the values of the properties. The size data that the size modeler 815 uses for the regression analysis is real estate data in the processed real estate data storage 845 that is related to the size of properties. As an example, for an apartment building, the size modeler 815 uses the average apartment size of the apartments in the apartment building for the regression analysis. In some embodiments, the size modeler 815 performs the regression analysis on the size data by using the estimation module 825 to define a relationship between the values of properties and the sizes of the properties.

The location modeler 820 handles the determination of a relationship between values of properties and the properties' locations. The location modeler 820 of some embodiments performs a regression analysis on the location of properties and the values of the properties. The location data that the location modeler 820 uses for the regression analysis is real estate data in the processed real estate data storage 845 that is related to the location of properties. In some embodiments, the location modeler 820 performs the regression analysis on the location data by using the estimation module 825 to define a relationship between the values of properties and the locations of the properties.

In addition to the location of properties themselves, the location modeler 820 of some embodiments considers the proximity of the properties relative to other points and/or areas that influence the desirability (or undesirability) of a location when determining the relationship. Hence, the additional data stored in the processed real estate data storage 845 of some embodiments includes data for assessing the location of a property (also referred to as location variables). Examples of location variables include the distance to subway stations; the density of restaurants, coffee shops, bars, clubs, etc.; the distance to shopping malls/areas; the distance to parks; the distance to rivers; the distance to mountains; etc. The distances may be expressed in terms of any of the geographic coordinate systems mentioned above.

In some embodiments, the location modeler 820 verifies the distances of the distance location variables. For instance, the location modeler 820 of some such embodiments uses the process described above by reference to FIG. 5 to verify the distances from the location of the property to the location of the location variable. In some embodiments, the location modeler 820 assigns weights to the location variables. This way, certain location variables can be specified as having a greater influence in the determination of the location of a property compared to other location variables.

The estimation module 825 receives several types of property data (e.g., location data and value data, size data and value data, quality data and value data, etc.) from the modelers 810-820 and provides a model of the relationship between the types of property data. As shown, the estimation module 825 includes a non-linear estimator 830, a linear estimator 835, and a semi-parametric estimator 840. One of ordinary skill in the art will recognize that additional and different types of estimators may be included in different embodiments. The estimation module 825 uses one or more of the estimators 830-840 to define the relationship between the types of property data.

The non-linear estimator 830 provides a non-linear model of the relationship between the types of property data while the linear estimator 835 provides a linear model of the relationship between the types of property data. The semi-parametric estimator 840 provides a semi-parametric model of the relationship between the types of property data. In some embodiments, the semi-parametric estimator 840 uses a third party tool (e.g., Stata®, which is provided by StataCorp LP) for providing the semi-parametric model.

The estimation module 825 uses different estimators for different types of property data. For example, in many instances, the estimation module 825 uses the linear estimator 835 to provide a linear relationship between the size of properties and the values of the properties. As another example, the estimation module 825 uses the semi-parametric estimator 840 to provide a between the location of properties and the values of the properties. In some embodiments, the estimation module 825 uses the set of estimators that yields the closest estimation of the relationship between of the types of property attributes.

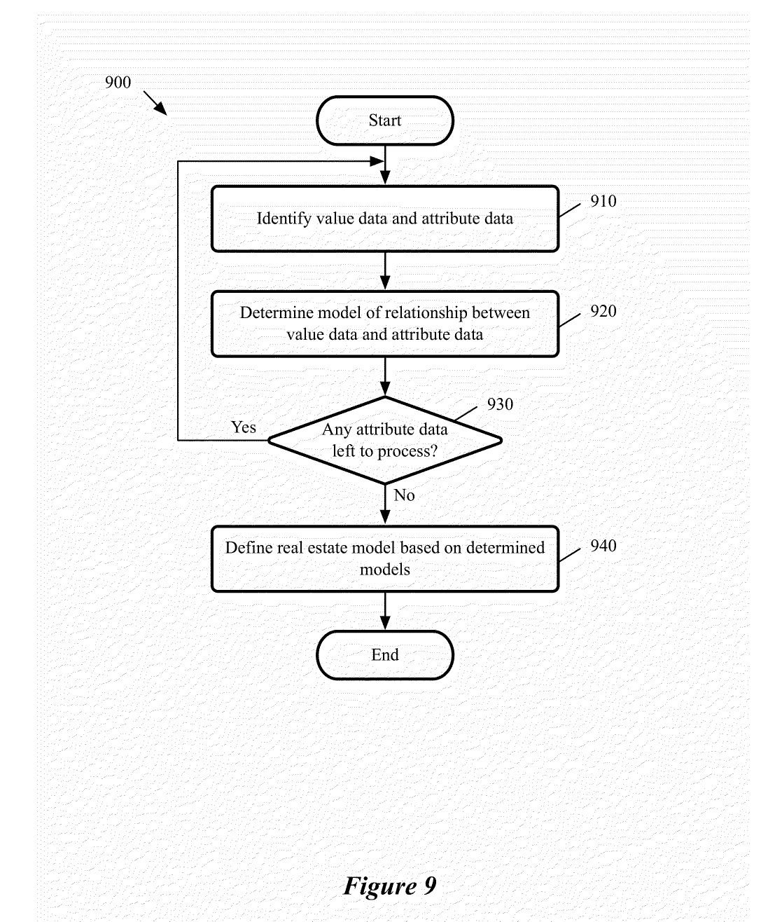

The operation of the real estate modeler 800 will now be described by reference to FIG. 9, which conceptually illustrated a process 900 of some embodiments for generating a real estate model. The process 900 starts by identifying (at 910) value data and attribute data for a property attribute. In some embodiments, the model generator 805 identifies the value data and the attribute data by retrieving real estate data from the processed real estate data storage 845. The model generator 805 sends the retrieved data to the appropriate modeler. In this example, the different types of attribute data include quality data (e.g., quality variables), size data, and location data (e.g., location variables). As such, the model generator 805 in this example sends value data of properties and quality variables of the properties to the quality modeler 810, the value data of the properties and size data of the properties to the size modeler 815, and the value data of the properties and location of the properties to the location modeler 820.

Next, the process 900 determines (at 920) a model of the relationship between the value data and the attribute data. When the quality modeler 810 receives the value data and the quality variables, the quality modeler 810 quantifies some or all of the quality variables. The quality modeler 810 then sends the data to the estimation module 825 for modeling. The estimation module 825 uses one or more of the estimators 830-840 to provide a model of the relationship between the value of the properties and the quality of the properties. The quality modeler 810 then sends the model to the model generator 805.

When the size modeler 815 receives the value data and the size data, the size modeler 815 sends the data to the estimation module 825 for modeling. The estimation module 825 uses one or more of the estimators 830-840 to provide a model of the relationship between the value of the properties and the size of the properties. The size modeler 815 then sends the model to the model generator 805.

When the location modeler 820 receives the value data, the location data, and the location variables, the location modeler 820 sends the data to the estimation module 825 for modeling. The estimation module 825 uses one or more of the estimators 830-840 to provide a model of the relationship between the value of the properties and the location of the properties. The location modeler 820 then sends the model to the model generator 805.

The process 900 then determines (at 930) whether any attribute data is left to process. When the process 900 determines that attribute data is left to process, the process 900 returns to 910 to continue processing any remaining attribute data. Otherwise, the process 900 proceeds to 940. For example, the process 900 might perform operations 910 and 920 for the quality data, then perform operations 910 and 920 for the size data, and then perform operations 910 and 920 for the location data before proceeding to 940.

Finally, the process 900 defines (at 940) a real estate model based on the determined models and then the process 900 ends. In some embodiments, once the model generator 805 receives the models from the modelers 810-820, the model generator 805 defines a real estate model based on the received models for determining a value of a property based on a location attribute, size attribute, and quality attribute of the property. Upon defining the real estate model, the model generator 850 stores the real estate model in the real estate models storage 850.

In some embodiments, a real estate model specifies a set of relationships between a set of attributes of properties and the properties' prices. The process 900 of some embodiments defines a real estate model using hedonic analysis to relate the price of properties to the properties' attributes. For instance, the process 900 uses hedonic analysis to define a real estate model that relates the price of properties to derived location, quality, and size attributes of the properties (e.g., derived location values for each property based on location variables associated with the property, derived size values for each property based on size variables associated with the property, and derived quality values for each property based on quality variables associated with the property).

In some embodiments, the real estate model is expressed in terms of a regression specification. The following is an example of a regression specification for relating the price of properties to the derived location, quality, and size attributes of the properties:

Average Price_{y}=ƒ(Latitudeᵢ,Longitudeᵢ)+βAverage Sizeᵢ+g(Qᵢ)+εᵢ

where Average Price, is the average of the listing or transaction prices of apartments in an apartment building i, ƒ is a non-linear function (e.g., a semi-parametric function, a non-parametric function, etc.) for capturing the relationship between the average of the listing or transaction prices of apartments in the apartment building i and the location of the apartments in the apartment building i, latitude, and latitude, represents the location of the apartment building i, β is a parameter (e.g., a scalar, a linear function, etc.) for capturing the relationship between the average of the listing or transaction prices of apartments in the apartment building i and average size of the apartments in the apartment building i, Average Sizeᵢ is the average size of the apartments in the apartment building i, g is a non-linear function (e.g., a semi-parametric function, a non-parametric function, etc.) for capturing the relationship between the average of the listing or transaction prices of apartments in the apartment building i and the quality of the apartments in the apartment building i, Qᵢ represents the quality variables of the apartments in the apartment building i, and i is the error term associated with the apartment building i. In some embodiments, ƒ is based on the average of the average price of apartments in apartment buildings within a defined radius (e.g., 1 kilometer, 2 kilometers, etc.) of the location of the apartment building i. In other words, for each apartment building within the defined radius of the location of the apartment building i, the average price of apartments in the apartment building is identified and the ƒ is based on the average of the identified average prices. Different embodiments may use different regression specifications to relating the price of properties to the derived location, quality, and size attributes of the properties.

In some embodiments, the process 900 performs regression analysis on the data for a set of properties (e.g., a sample set of properties) in order to determine a set of estimates \hat{ƒ}, \hat{β} and ĝ. In particular, the process 900 performs regression analysis on price of the properties (e.g., Average Priceᵢ price of the properties, etc.) and the derived location (e.g., latitudeᵢ and latitudeᵢ, distance to center of the city, etc.), quality (e.g., quality of the properties, etc.), and size (e.g., Average Sizeᵢ size of the properties) attributes of the properties. Once the process 900 determines \hat{ƒ}, \hat{β} and ĝ for the regression specification, some embodiments use the determined estimators to predict the value of each attribute of a particular property, and, in turn, predict the total value of the particular property. \hat{ƒ}, \hat{β} and ĝ be used to determine the value of any property in some embodiments. For example, \hat{ƒ}, \hat{β} and ĝ may be used to predict the value of the properties that were used for the regression analysis to determine \hat{ƒ}, \hat{β} and ĝ. As another example, \hat{ƒ}, \hat{β} and ĝ may be used to predict the value of the properties other than the properties that were used for the regression analysis to determine \hat{ƒ}, \hat{β} and ĝ.

B. Valuing Real Estate Using a Real Estate Model

Once a real estate model has been generated by a real estate modeler (e.g., the real estate modeler described above by reference to FIGS. 1, 7, and 11), the real estate model can be used to determine a value of a property. As described above, the system of some embodiments determined the value of a property based on several attributes of the property. For instance, based on a real estate model, the system of some embodiments determines a value for a location attribute, a value for a size attribute, and a value for a quality value of the property. The total value of the property is the sum of the attribute values.

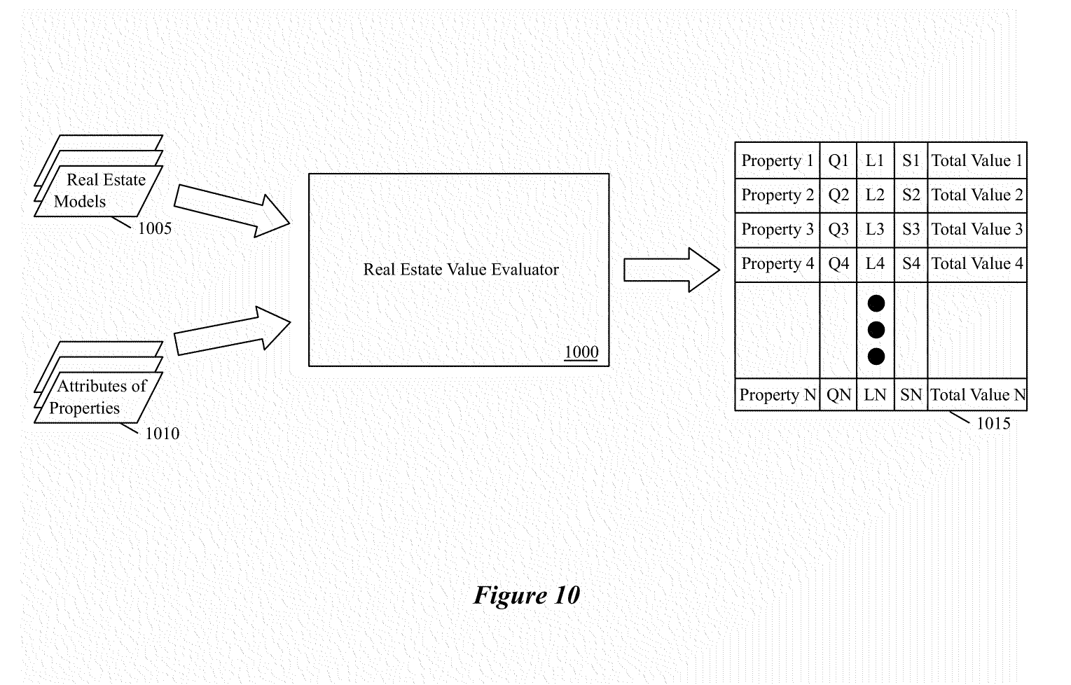

FIG. 10 conceptually illustrates the input and output of a real estate value evaluator 1000 of some embodiments. As shown, real estate models 1005 and sets of attributes of properties 1010 are input to the real estate value evaluator 1000. In some embodiments, the real estate value evaluator 1000 identifies a set of attributes of a property 1010 and uses the set of real estate models 1005 to determine a value for each attribute in the set of attributes of the property 1010. The value of the property is the sum of the values determined for the attributes of the property. The real estate value evaluator 1000 outputs the attribute values and the total value of each property that the real estate value evaluator 1000 evaluates. As illustrated in FIG. 10, the real estate value evaluator 1000 in this example outputs a set of attribute values and total values 1015 for N number of properties. The real estate value evaluator 1000 determines a quality value (e.g., Q1), a size value (e.g., S1), a location value (e.g., L1), and a total value (e.g., total value 1) for each property.

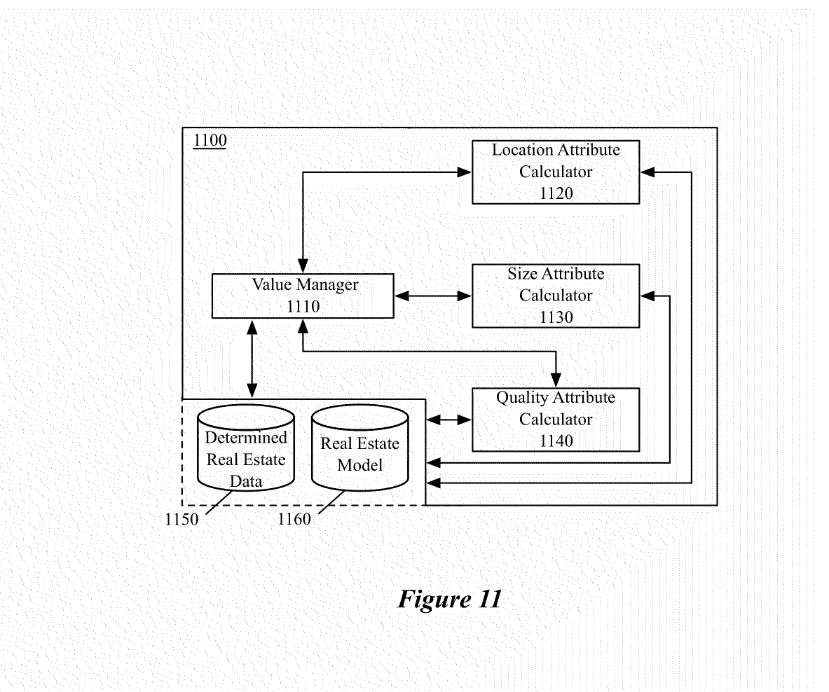

FIG. 11 conceptually illustrates a software architecture of a real estate value evaluator 1100 of some embodiments. In some embodiments, the real estate value evaluator 1100 is a module that receives real estate models and sets of attributes of properties, and outputs a set of attribute values and total values, as illustrated in FIG. 10. As shown, the real estate value evaluator 1100 includes a value manager 1110, a location attribute calculator 1120, a size attribute calculator 1130, and a quality attribute calculator 1140. FIG. 11 also shows a real estate models storage 1160 and a determined real estate data storage 1150. In some embodiments, the data storages 1150 and 1160 are implemented as one physical storage. In other embodiments, the real estate models and the determined real estate data are stored in separate physical storages. The processed real estate models storage 1160 is similar the processed real estate data storage described above by reference to FIG. 8, in some embodiments.

The value manager 1110 is responsible for determining the values of properties based on a set of real estate models. The value manager 1110 of some embodiments determines the values of each of the properties for which data has been collected, processed, and used to define real estate models. In some embodiments, the value manager 1110 determines the values of a portion of the properties of which data has been collected, processed, and used to define real estate models. Still, the properties of which the value manager 1110 determines the values is different from the properties of which data has been collected, processed, and used to define real estate models.

In some embodiments, the value manager 1110 uses the calculators 1120-1140 to determine the value of a property. To determine the value of a property, the value manager 1110 of some embodiments identifies a set of attributes of the property and a set of real estate models in the real estate model storage 1160. In some embodiments, the set of attributes that the value manager 1110 identifies is data that has been processed by a real estate data process of some embodiments (e.g., the real estate data processor described above by reference to FIGS. 1, 3, 4, and 23). As such, in some such embodiments, the value manager 1110 identifies the set of attribute for properties from a processed real estate data storage (not shown in FIG. 11), such as the ones described above by reference to FIGS. 4 and 8. The value manager 1110 sends some or all of the data to each of the calculators 1120-1140 to determine a value for a corresponding attribute of the property.

The location attribute calculator 1120 determines values for the location attribute of properties. In some embodiments, the location attribute calculator 1120 determines the value for the location attribute of a property based on a set of real estate models and location data (e.g., location variables) of the property. The location attribute calculator 1120 of some embodiments accesses the real estate model storage 1160 to identify the set of real estate models and receives the location data from the value manager 1110.

As noted above, the real estate model of some embodiments specifies a relationship between the value of a property and a set of attributes of the property. Thus, in some embodiments, the location attribute calculator 1120 determines the value for the location attribute of a property by providing a real estate model the location data of the property and identifying the corresponding value provided by the real estate model. As described above, the real estate model of some embodiments is expressed in terms of a function. Based on the example regression specification described above by reference to FIG. 9, the location attribute calculator 1120 of some embodiments uses the following equation (2) to determine the value for the location attribute of a property:

Location Valueᵢ=:\hat{ƒ}(Latitudeᵢ,Longitudeᵢ)+\hat{β}Min Apt Size+ĝ(Min Quality)

where Location Valueᵢ is the determined value for the location of an apartment in an apartment building i, \hat{ƒ} is the estimator of ƒ in the regression specification noted above after a regression analysis has been performed on a sample set of properties, latitude, and latitude, represents the location of the apartment building i, \hat{β} is the parametric estimator of in the regression specification mentioned above after a regression analysis has been performed on the sample set of properties, Min Apt Size is the size of the smallest apartment in the sample of properties, ĝ is the estimator of g in the regression specification provided above after a regression analysis has been performed on the sample set of properties, Min Quality represents the quality variables of the lowest quality apartment in the sample of properties. After the location attribute calculator 1120 determines the value for the location attribute of the property, the location attribute calculator 1120 sends the determined value to the value manager 1110.

The size attribute calculator 1130 handles the determination of values for the size attribute of properties. The size attribute calculator 1130 of some embodiments determines the value for the size attribute of a property based on a set of real estate models and size data of the property. In some embodiments, the size attribute calculator 1130 accesses the real estate model storage 1160 to identify the set of real estate models and receives the size data from the value manager 1110.

As noted above, the real estate model of some embodiments specifies a relationship between the value of a property and a set of attributes of the property. Therefore, the size attribute calculator 1130 of some embodiments determines the value for the size attribute of a property by providing a real estate model the size data of the property and identifying the corresponding value provide by the real estate model. As described above, the real estate model of some embodiments is expressed in terms of a function. Based on the example regression specification described above by reference to FIG. 9, the size attribute calculator 1130 of some embodiments uses the following equation (3) to determine the value for the size attribute of a property:

Size Value_{i,k}=\hat{β}(Size_{i,k}−Min Apt Size)

where Size Value_{i,k} is the determined value for the size of apartment k in an apartment building i, \hat{β} is the parametric estimator of β in the regression specification mentioned above after a regression analysis has been performed on a sample set of properties, Size_{i,k} is the size of apartment k in the apartment building i, Min Apt Size is the size of the smallest apartment in the sample of properties. Once the size attribute calculator 1130 determines the value for the size attribute of the property, the size attribute calculator 1130 sends the determined value to the value manager 1110.

The quality attribute calculator 1140 determines values for the quality attribute of properties. In some embodiments, the quality attribute calculator 1140 determines the value for the quality attribute of a property based on a set of real estate models and quality data (e.g., quality variables) of the property. In some embodiments, the quality attribute calculator 1140 accesses the real estate model storage 1160 to identify the set of real estate models and receives the size data from the value manager 1110.

As noted above, the real estate model of some embodiments specifies a relationship between the value of a property and a set of attributes of the property. Thus, the quality attribute calculator 1140 of some embodiments determines the value for the quality attribute of a property by providing a real estate model the quality data of the property and identifying the corresponding value provide by the real estate model. As described above, the real estate model of some embodiments is expressed in terms of a function. Based on the example regression specification described above by reference to FIG. 9, the quality attribute calculator 1140 of some embodiments uses the following equation (4) to determine the value for the quality attribute of a property:

Quality Valueᵢ=ĝ(Qᵢ)−ĝ(Min Quality)

where Quality Valueᵢ is the determined value for the quality of an apartment in an apartment building i, ĝ is the estimator of g in the regression specification provided above after a regression analysis has been performed on a sample set of properties, Qᵢ represents the quality variables of the apartments in the apartment building i. Min Quality represents the quality variables of the lowest quality apartment in the sample of properties. After the quality attribute calculator 1140 determines the value for the quality attribute of the property, the quality attribute calculator 1140 sends the determined value to the value manager 1110.

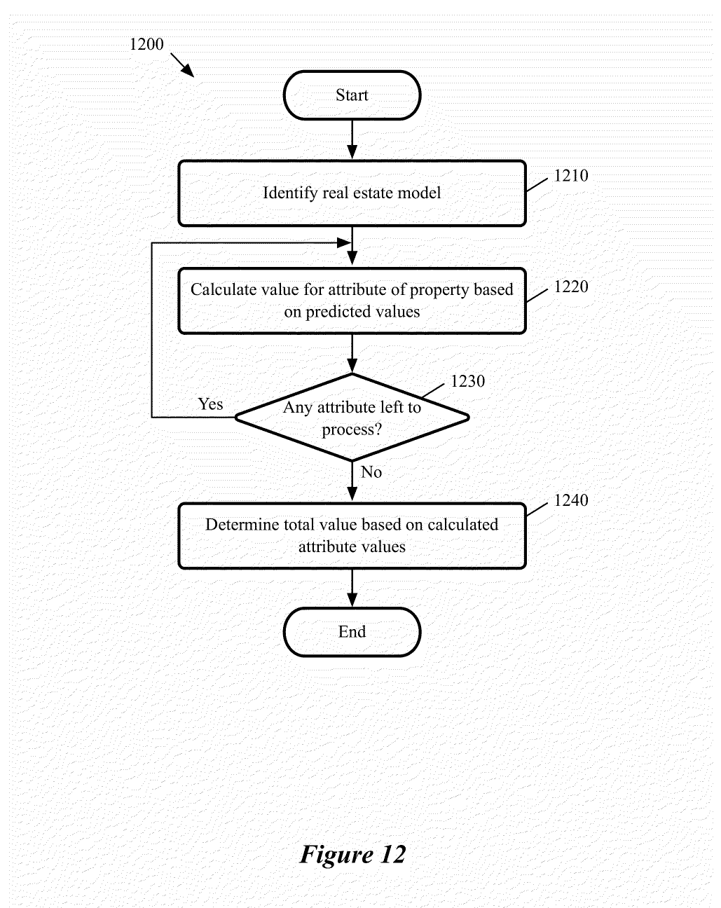

The operation of the real estate value evaluator 1100 will now be described by reference to FIG. 12, which conceptually illustrates a process 1200 of some embodiments for evaluating a value for a property. The process 1200 begins by identifying (at 1210) a real estate model. In some embodiments, the value manager 1110 identifies the real estate model by retrieving real estate model from the real estate model storage 1160. The value manager 1110 sends the retrieved real estate model each of the calculators 1120-1140. In some embodiments, the value manager 1110 identifies the real estate model in the real estate model storage 1160 and instructs each of the calculators 1120-1140 to retrieve the identified real estate model from the real estate model storage 1160.

Next, the process 1200 calculates (at 1220) a value for the attribute of the property based on the real estate model. When each of the calculators 1120-1140 receives the real estate model, the calculator calculates the value for the corresponding attribute of the property. Different embodiments use different techniques to calculate the value for the attribute of the property. For instance, the location attribute calculator 1120 may calculate the value for the location attribute of the property using the equation (2) that is mentioned above. The size attribute calculator 1130 may calculate the value for the size attribute of the property using the equation (3) noted above. As another example, the quality attribute calculator 1140 may calculate the value for the quality attribute of the property using the equation (4) described above. Each calculator 1120-1140 sends the value manager 1110 the value calculated by the calculator.

The process 1200 then determines (at 1230) whether any attribute is left to process. When the process 1200 determines that an attribute is left to process, the process 1200 returns to 1220 to continue processing any remaining attributes. Otherwise, the process 1200 proceeds to 1240.

For example, the process 1200 might perform operation 1220 for the location attribute, then perform operation 1220 for the size attribute, and then perform operation 1220 for the quality attribute before proceeding to 1240.

Finally, the process 1200 determines (at 1240) the predicted value of the property based on the calculated attribute values and then the process 1200 ends. In some embodiments, the value manager 1110 determines the total value of the property by calculating the sum of the values that the value manager 1110 receives from the calculators 1120-1140. Using the example equations (2)-(4), the value manager 1110 of such embodiments determines the total value of the property using the following equation (5):

Predicted Price_{i,k}=Location Valueᵢ+Size Value_{i,k}+Quality Valueᵢ

where Predicted Price_{i,k} is the determined (or predicted value) of apartment k in an apartment building i, Location Valueᵢ is the determined value for the location of an apartment in an apartment building i, Size Value_{i,k} is the determined value for the size of apartment k in an apartment building i, and Quality Valueᵢ is the determined value for the quality of an apartment in an apartment building i. In some embodiments, the Location Valueᵢ the Size Value_{i, k}, and the Quality Valueᵢ are referred to as hedonic component price values since the values are the generated from the hedonic analysis. As illustrated by equation (5), each hedonic component price value represents a portion of the total value of a property that is attributed to an attribute of the property. In particular, the Location Valueᵢ is attributed to the location of a property, the Size Value_{i,k} is attributed to the size of the property, and the Quality Valueᵢ is attributed to the quality of the property. In addition, the Location Valueᵢ, the Size Value_{i,k}, and the Quality Valueᵢ may be referred to as predicted values or hedonic predicted values that each represents a portion of a predicated total value of a property that is attributed to an attribute of the property.

In some embodiments, the process 1200 stores the computed hedonic component price values for each property so that these values can be later used (e.g., by a real estate search engine) to evaluate the properties to process search queries. However, instead of storing the computed hedonic component price values, the process 1200 of some embodiments store values that are derived from the hedonic component price values to express the fractional contribution of each of the several attributes (e.g., quality attribute, size attribute, location attribute, etc.) to the determined price (e.g., the predicted price) of the property. For instance, in some embodiments, the process 1200 stores the hedonic component price values in terms of fractional values of the determined price (e.g., normalizing the hedonic component price values to a 0-1 scale by dividing each the hedonic component price value by the determined price). The process 1200 of other embodiments stores the hedonic component price values in any other type of representation of the hedonic parametric values.

The equation (5) can also be expressed by the following equation (6):

Predicted Price_{i,k}=\hat{ƒ}(Latitudeᵢ,Longitudeᵢ)+\hat{β}Size_{i,k}+ĝ(Qᵢ)

where Predicted Price_{i,k} is the determined value of apartment k in an apartment building i, \hat{ƒ} is the estimator of ƒ in the regression specification noted above after a regression analysis has been performed on a sample set of properties, latitude, and latitude, represents the location of the apartment building i, \hat{β} is the parametric estimator of in the regression specification mentioned above after a regression analysis has been performed on the sample set of properties, Size_{i,k} is the average size of apartment k in the apartment building i, ĝ is the estimator of g in the regression specification provided above after a regression analysis has been performed on the sample set of properties, and Qᵢ represents the quality variables of the apartments in the apartment building i. After determining the total value of the property, the value manager 1110 stores the determined value in the determined real estate data storage 1150. While \hat{ƒ}, \hat{β} and ĝ in equation (6) are estimations of ƒ, β, and g in the regression specification described above, one of ordinary skill in the art will recognize that any of \hat{ƒ}, \hat{β} and ĝ may be any type of estimator (e.g., linear, non-linear, etc.) in different embodiments (e.g., when using different regression specifications).

As described above, the real estate value evaluator of some embodiments determines values of properties based on a set of attributes of the property. For example, the real estate value evaluator (1) calculates a value (e.g., a hedonic component price value) for each attribute in the set of attributes of the property, (2) adds the determined attribute values together to determine the total value of the property, and (3) stores a representation of the attribute values. In some embodiments, the real estate value evaluator generates and stores a data structure to represent the information.

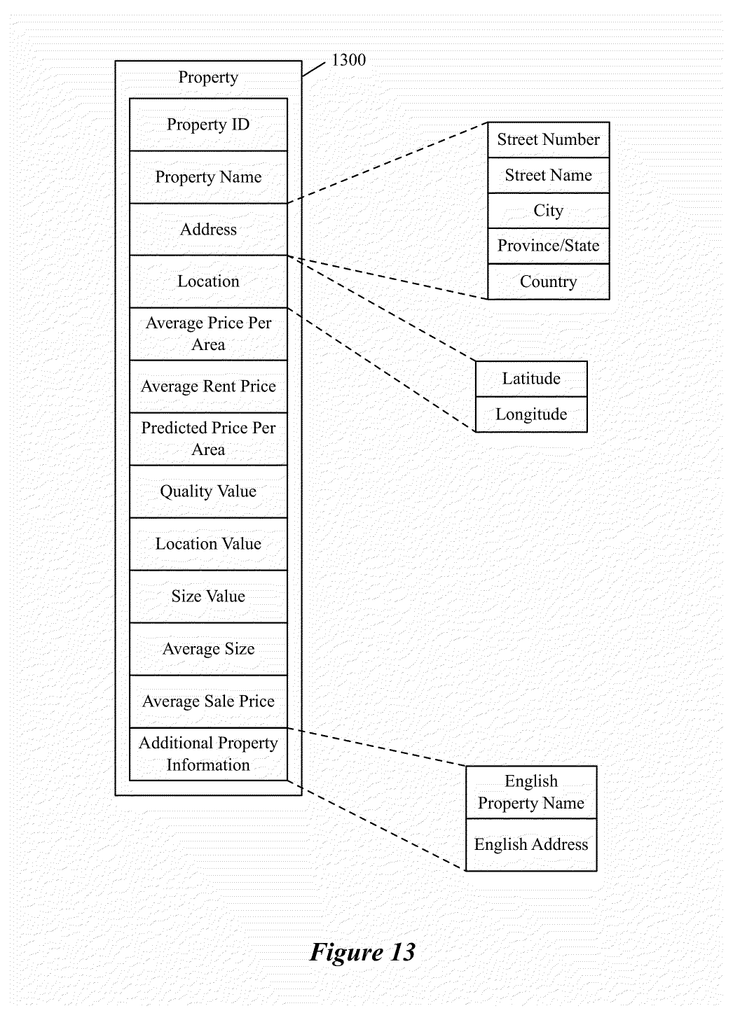

FIG. 13 conceptually illustrates a data structure 1300 for a property according to some embodiments of the invention. In some embodiments, a real estate value evaluator (e.g., the real estate value evaluator described above and below by reference to FIGS. 1, 10, 11, and 23) creates and stores the data structures 1300 when the real estate value evaluator has determined a value for the property For this example, the data structure 600 stores data that represents an apartment in an apartment building (e.g., a property that includes several apartments).

As shown, the data structure 1300 includes a property identifier (ID) field, a property name field, an address field, a location field, an average price per area field, an average rent price field, a predicated price per area field, a quality value field, a location value field, a size value field, an average sale price field, an average size field, and an additional information field. For this example, the property ID field, property name field, address field, location field, average price per area field, average rent price field, average size field, and additional information field are similar to the corresponding fields in the data structure 600, which is described above by reference to FIG. 6.

The predicted price per area field represents the price per square meter based on the value determined for the property using a set of real estate models. In some embodiments, the price per area field of some embodiments represents the average price per square feet. Other units may be used as well (e.g., square inches, square centimeters, etc.) in other embodiments.

The quality value field is the value for the quality attribute of the property that is determined based on the set of real estate models. The location value field is the value for the location attribute of the property that is determined based on the set of real estate models, and the size value field is the value for the size attribute of the property that is determined based on the set of real estate models. The average sale price field represents the average sale price per square meter based on the value determined for the property using a set of real estate models. The average sale price field represents the average price for which the apartments in the apartment building are offered for sale.

### III. Real Estate Search Engine

As described in the sections above, the system of some embodiments identifies real estate data and processes the real estate data. The system uses the processed real estate data to define real estate models for determining values of properties based on values determined for attributes of the properties. In some embodiments, a real estate search engine uses the determined values to search for properties across the attributes of the properties.

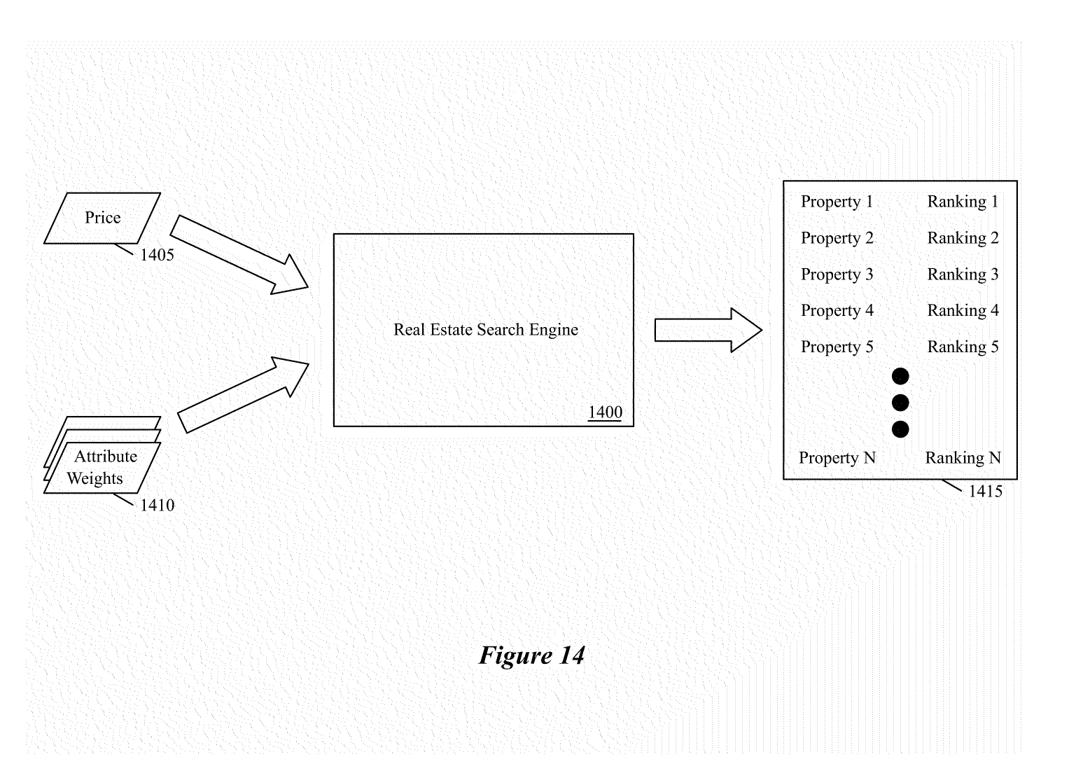

FIG. 14 conceptually illustrates the input and output of a real estate search engine 1400 of some embodiments. As illustrated in this figure, a price 1405 and a set of attribute weights 1410 are input to the real estate search engine 1400. In some embodiments, the real estate search engine 1400 identifies a set of properties that have a determined value that is within a defined percentage more or less (e.g., +/−3 percent, +/−6 percent, +/−10 percent, etc.) than the price 1405. In some embodiments, the real estate search engine 1400 identifies a set of properties that have a determined value that is within a defined amount more or less (e.g., +/−$500, +/−$1,000, +/−$10,000, etc.) than the price 1405. Still, in some embodiments, the real estate search engine 1400 uses both of the aforementioned methods, additional methods, or different methods.

The real estate search engine 1400 ranks the identified properties based on the attribute weights 1410. In some embodiments, the attribute weights 1410 are values that specify the weight to assign to each attribute in a set of property attributes. The real estate search engine 1400 of some embodiments ranks properties with a distribution of attribute values that are similar to the distribution of the attribute weights 1410 are higher than properties with a distribution of attribute values that are less similar to the distribution of the attribute weights 1410.

After ranking the identified properties, the real estate search engine 1400 outputs a ranked set of properties 1415. In some embodiments, the real estate search engine 1400 outputs a defined number (e.g., 10, 20, 25, 50, 100, etc.) of the highest ranked properties. For this example, the real estate search engine 1400 outputs N of the highest ranked properties. In other embodiments, the real estate search engine 1400 outputs a defined percentage (e.g., 5 percent, 10 percent, 20 percent, etc.) of the highest ranked properties.

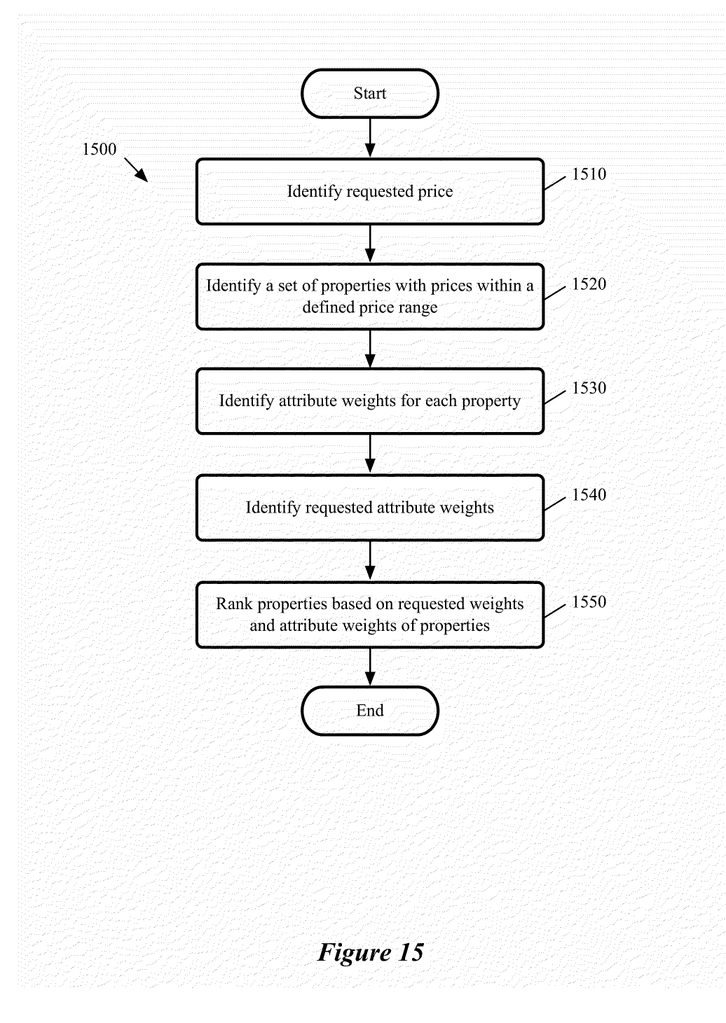

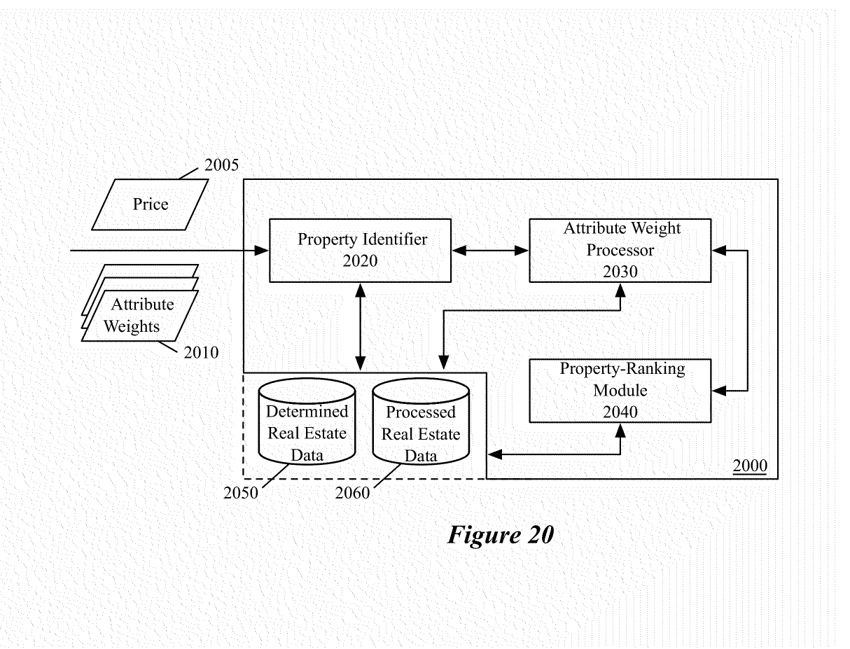

FIG. 15 conceptually illustrates a process of some embodiments for processing a real estate search query. In some embodiments, the process 1500 is performed by a real estate search engine, such as the one described above and below by reference to FIGS. 14 and 20. The real estate search engine of some such embodiments performs the process 1500 when a request to perform a search for properties is received. Such a request may be received from a hypertext transfer protocol (HTTP) request, a web-based service, an application programming interface (API), etc.

The process 1500 begins by identifying (at 1510) a requested price. In some embodiments, the requested price specifies to search for properties having prices that are the same or similar to the requested price. The requested price may be a request for a rental price for a property (e.g., rent price per month), a sale price of property, a day rate for a property (e.g., a hotel room), etc.). As such, some embodiments express the requested price in terms of price, price/month, price/night, etc.

Next, the process 1500 identifies (at 1520) a set of properties that have prices within a defined price range of the requested price. This way, the process 1500 identifies searchable properties having prices that are the same or similar to the requested price. In some cases, the identified set of properties is a subset of all the searchable properties. As mentioned above, in some embodiments, the price range is defined in terms of a percentage (e.g., +/−3 percent, +/−6 percent, +/−10 percent, etc.) of the requested price. In some instances, the price range of some embodiments is defined in terms of an amount greater than or less (e.g., +/−$500, +/−$1,000, +/−$10,000, etc.) than the requested price. Still, in some embodiments, the real estate search engine 1400 uses both of the aforementioned methods, additional methods, or different methods to define the price range.

The process 1500 then identifies (at 1530) attributes weights for each of the identified properties. In some embodiments, an attribute weight for a property is the value determined for the attribute of the property. For instance, the location value, size value, and quality value determined by a real estate value evaluator described above by reference to FIGS. 10 and 11 are examples of attribute weights.

After identifying attribute weights for the identified properties, the process 1500 identifies (at 1540) the requested attribute weights. In some embodiments, the requested attribute weights are for specifying properties that have the same or similar corresponding attribute weights. In other words, requested attribute weights are for specifying properties that have the same or similar distribution attribute weights as the distribution of the requested attribute weights.

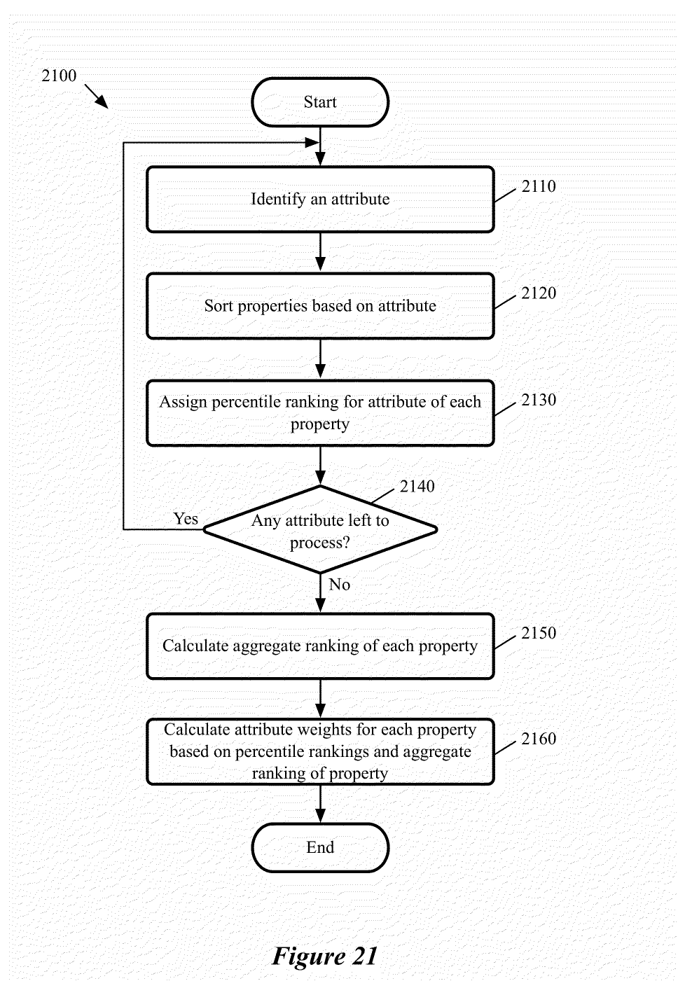

Finally, the process 1500 ranks (at 1550) properties based on the requested attribute weights and the attribute weights of the identified properties. In some embodiments, the process 1500 ranks the properties so that the properties that match the requested attribute weights more closely are ranked higher than the properties that do not match the requested attribute weights so closely. Different embodiments use different techniques to rank properties based on the requested attribute weights and the attribute weights of the identified properties. For instance, the process 1500 of some embodiments normalizes the attributes weights for the identified properties and the requested attribute weights to a common scale (e.g., a 0-1 scale) in order to compare the attribute weights. Several techniques for ranking properties are described below by reference to FIGS. 20 and 21.

As mentioned above, a request to perform a search for properties may be received from a hypertext transfer protocol (HTTP) request, a web-based service, an application programming interface (API), etc. Different embodiments use different tools to create such requests. One such tool is a graphical user interface (GUI) for creating a request.

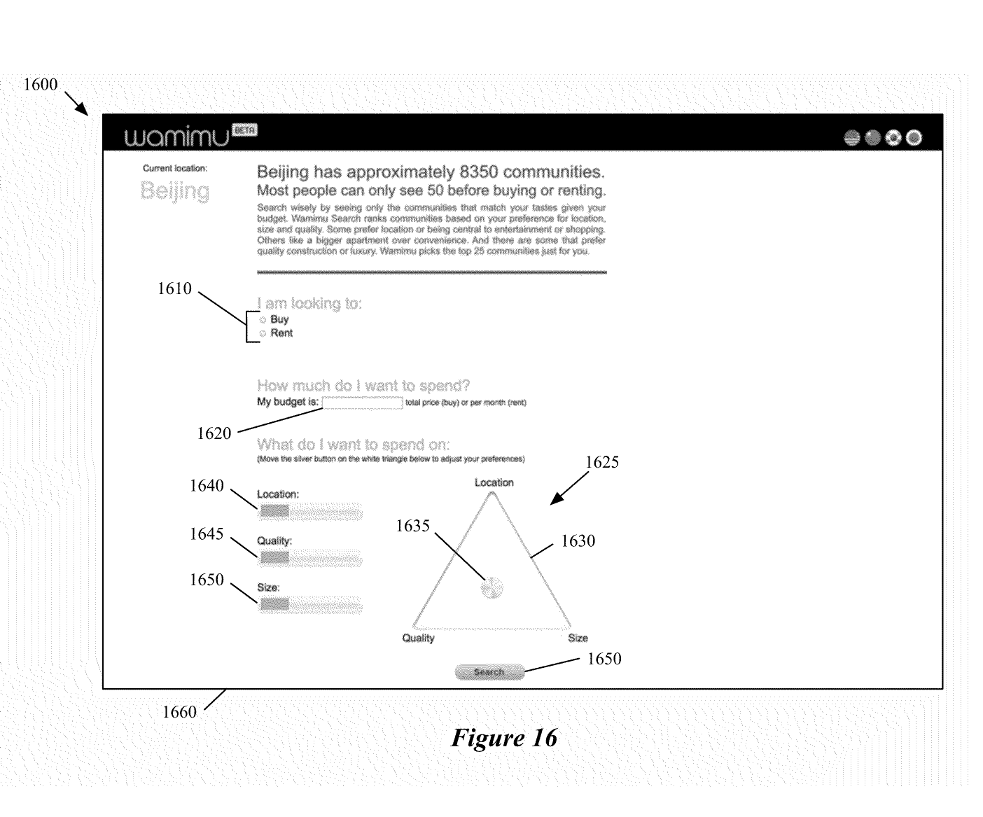

FIGS. 16-18 conceptually illustrate an example GUI 1600 for creating a search query for property. Specifically, FIGS. 16-18 illustrate the GUI 1600 at three different stages 1660-168 of specifying a search query for property.

As shown in FIGS. 16-18, the GUI 1600 includes selectable user interface (UI) items 1610 and 1655, a UI text input item 1620, an adjustable requested attribute weight selection control 1625, and a set of requested attribute weight indicators 1640-1650. In some embodiments, the GUI 1600 is provided by a standalone application, a web-based service (e.g., for display in a web-browser), etc.

The selectable UI item 1610 (e.g., the set of radio buttons) is for selecting a type of property for which to search. In this example, the UI item 1610 is for selecting between properties for rent and properties for sale. One type of property (properties for sale this example) is selected when the GUI 1600 receives a selection (e.g., through a cursor control operation such as clicking a mouse button, tapping a trackpad, or touching a touchscreen) of the top portion of the selectable UI item 1610 (e.g., the top radio button for a “Buy” option). Another type of property option (properties for rent in this example) is selected when the GUI 1600 receives a selection (e.g., through a cursor control operation such as clicking a mouse button, tapping a trackpad, or touching a touchscreen) of the bottom portion of the selectable UI item 1610 (e.g., the button radio button for a “Rent” option).

The UI text input item 1620 (e.g., the “My Budget” text input field) is for receiving a price (e.g., an integer value) that is for specifying properties that have a particular price (e.g., the request price described above by reference to FIG. 15). Different methods may be used to provide input to the UI text input item 1620. For instance, input may be provided from keystrokes through a keyboard device or a virtual keyboard on a touchscreen. Other methods for entering numerical input are possible.

The adjustable attribute weight selection control 1625 is for specifying requested weights for each attribute in a set of property attributes. As shown, in this example, the adjustable attribute weight selection control 1625 is for specifying weights for a location attribute, a size attribute, and a quality attribute. The adjustable attribute weight selection control 1625 includes a selection area 1630 and an attribute weight selector 1635 that is movable within the selection area 1630. The attribute weights associated with the adjustable attribute weight selection control 1625 are specified based on the position of the attribute weight selector 1635 in the selection area 1630.

Conceptually, the adjustable attribute weight selection control 1625 is for specifying amounts of a budget (e.g., the value specified in the UI text input item 1620) to “spend” on different attributes when searching for properties. That is, the adjustable attribute weight selection control 1625 is for specifying a portion of the value specified in the UI text input item 1620 for each attribute in the set of property attributes based on the position of the attribute weight selector 1635 in the selection area 1630. For example, if a budget of 600 is specified in the UI text input item 1620 and the attribute weight selector 1635 is positioned in center of the selection area 1630, 200 is allocated to each attribute. As another example, if 600 is specified in the UI text input item 1620 and the attribute weight selector 1635 is positioned all the way towards the vertex of the selection area 1630 that corresponds to the quality attribute (i.e., the lower left vertex of the selection area 1630), the entire 600 is allocated to the quality attribute and nothing is allocated to the location attribute and the size attribute.

The set of attribute weight indicators 1640-1650 each graphically represents the amount of a corresponding attribute weight based on the position of the attribute weight selector 1635 in the selection area 1630. In some embodiments, the GUI 1600 adjusts the attribute weight indicators 1640-1250 in real-time, in response to the positioning of the attribute weight selector 1635 in the selection area 1630. In this manner, the attribute weight indicators 1640-1650 provide visual feedback of the amount of each attribute weight relative to other attribute weights. That is, the attribute weight indicators 1640-1650 collectively display the relative distribution of attribute weights among the attributes.

The selectable UI item 1655 (e.g., the Search button) is for initiating a search query for properties based on parameters specified by the selectable UI item 1610, the UI input text item 1620, and the adjustable attribute weight selection control 1625. In some embodiments, the search query specifies to search for properties that (1) have the same or similar price as the value specified by the UI input text item 1620 and (2) have the same or similar distribution of attribute weights as the attribute weights specified by the adjustable attribute weight selection control 1625. When the GUI 1600 receives a selection of the UI item 1655 (e.g., through a cursor control operation such as clicking a mouse button, tapping a trackpad, or touching a touchscreen), the GUI 1600 sends the search query to a real estate search engine of some embodiments to process the search request. In some such embodiments, the real estate search engine performs the process 1500, which is described above by reference to FIG. 15, to perform the search query.

FIG. 16 illustrates the first stage 1660 of the GUI 1600 that is for specifying a search query. At this stage, the GUI 1600 a property type has not been selected, a price has not been specified, and the adjustable attribute weight selection control 1625 is in a default state. In particular, the attribute weight selector 1635 in positioned in the middle of the selection area 1630. Accordingly, the attribute weight indicators 1640-1650 indicate that the attribute weights for the location attribute, the quality attribute, and the size attribute are the same or substantially the same.

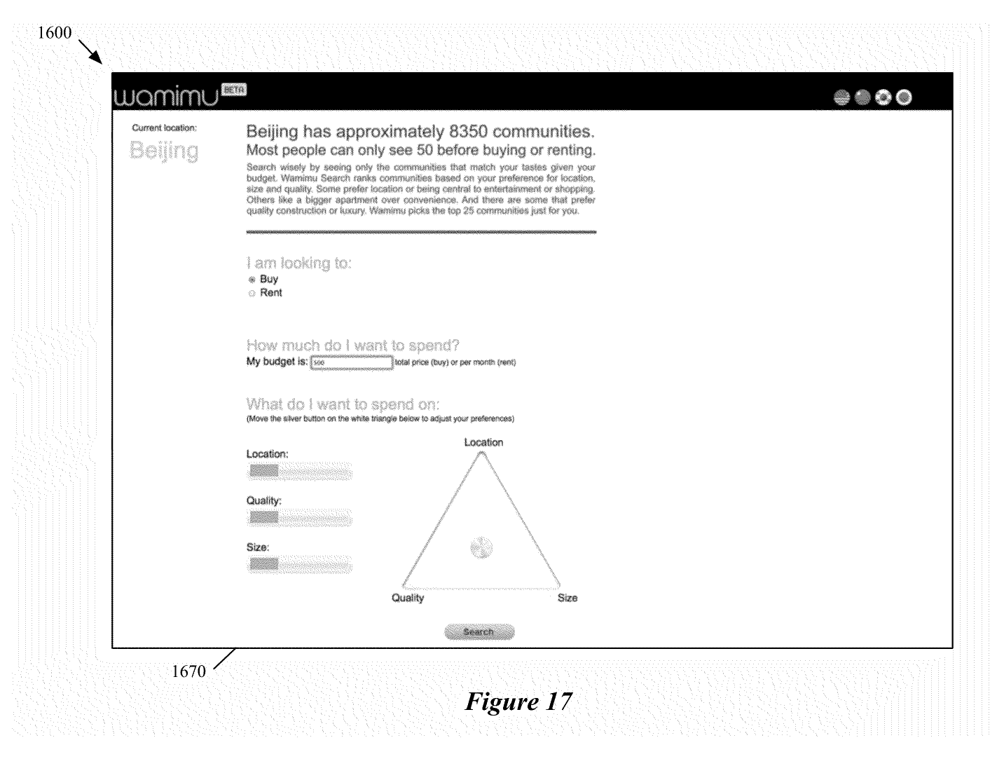

FIG. 17 shows the second stage 1670 of the GUI 1600 after a property type and a price has been specified. As shown in this stage, a user has selected (e.g., through a cursor control operation such as clicking a mouse button, tapping a trackpad, or touching a touchscreen) the “Buy” option of the selectable UI item 1610, which specifies to search for properties for sale. The second stage 1670 also illustrates that the user has entered a value of “500” (e.g., by using a keyboard device, a virtual keyboard on a touchscreen, or any other type of method for entering numerical input) in the UI text field 1620.

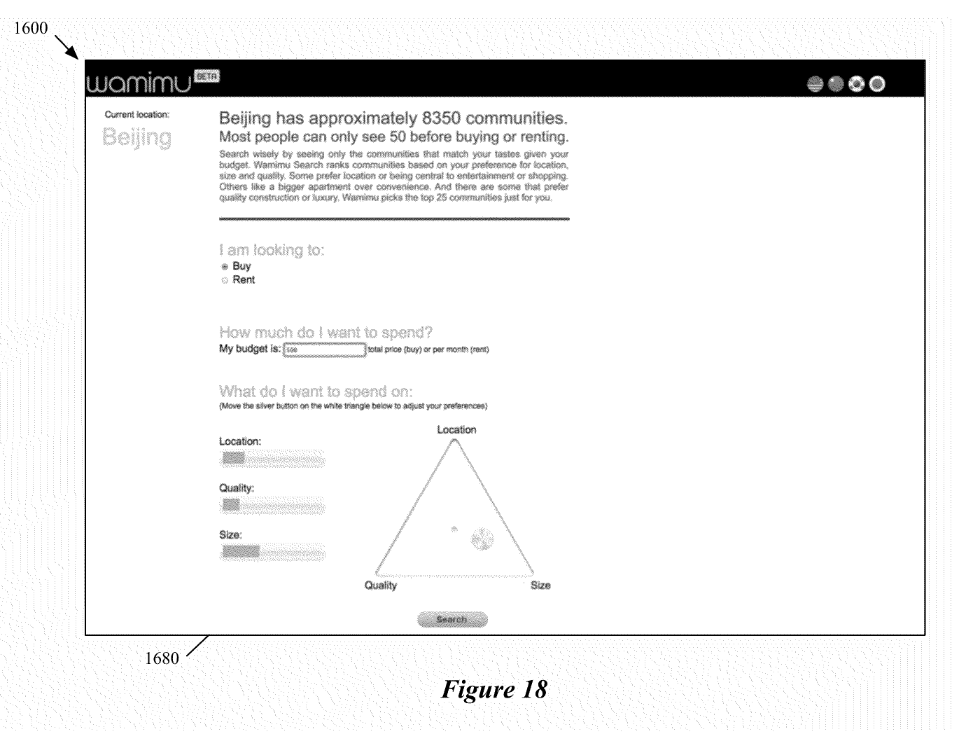

FIG. 18 illustrates the third stage 1680 of the GUI 1600 after the attribute weights have been adjusted. In the third stage 1680, the user has moved the attribute weight selector 1635 (e.g., through a cursor control operation such as a click-and-drag operation using a mouse, a trackpad, a touchscreen, etc.) down and towards the right from the default position shown in the stages 1660 and 1670. In response to the adjustment of the attribute weight selector 1635, the GUI 1600 adjusts in real-time the attribute weight indicators 1640-1650 to indicate the attribute weights of the attributes. As shown in the third stage 1680, by moving the attribute weight selector 1635 towards the size attribute of the attribute weight selection control 1625, the GUI 1600 has correspondingly increased the amount of the indicator bar in the attribute weight indicator 1650 for the size attribute. The GUI 1600 has also decreased the amount of the indicator bar in each of the attribute weight indicators 1645 and 1650 for the location and quality attributes, respectively.

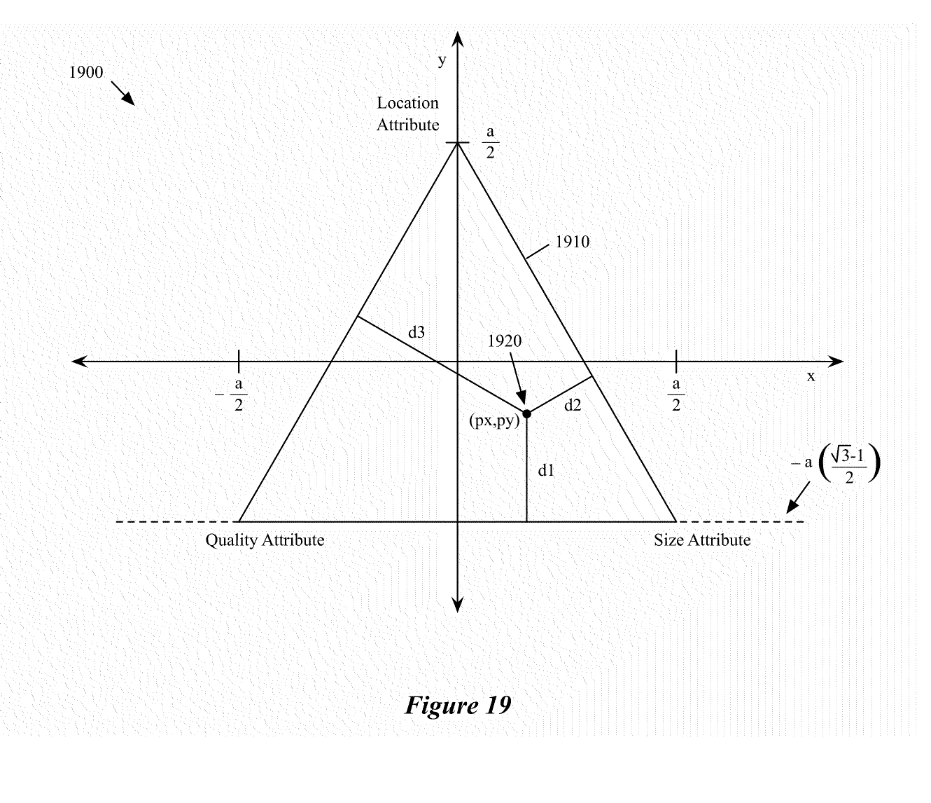

As discussed above, the attribute weights associated with the adjustable attribute weight selection control 1625 are specified based on the position of the attribute weight selector 1635 in to the selection area 1630. FIG. 19 conceptually illustrates attribute weights that are determined based on an example position of a attribute weight selector of some embodiments. In particular, FIG. 19 illustrates attribute weights that are determined based on the position of the attribute weight selector 1635 in the third stage 1680 shown in FIG. 18. In some embodiments, the GUI 1600 determines the attributes weights for the location, quality, and size attributes using the example technique illustrated in FIG. 19.

FIG. 19 shows a triangle 1910 that represents the selection area 1630 illustrated in FIGS. 16-18. The triangle 1910 is displayed in a Cartesian coordinate system graph 1900 having an x-axis and a y-axis. The triangle 1910 is an equilateral triangle with sides of length a. The length a may be defined as any positive number (e.g., 1, 5, 10, 50, etc.). As illustrated in FIG. 19, the lower left vertex of the triangle 1910, which corresponds to the quality attribute, has the following coordinate:

$$( - \frac{a}{2} , - a ( \frac{\sqrt{3} - 1}{2} ) )$$

The top vertex of the triangle 1910, which corresponds to the location attribute, has the following coordinates:

$$( 0 , \frac{a}{2} )$$

The lower right vertex of the triangle 1910, which corresponds to the size attribute, has the following coordinates:

$$( \frac{a}{2} , - a ( \frac{\sqrt{3} - 1}{2} ) )$$

A point 1920 in the triangle 1910 represents the position of the attribute weight selector 1635 in the selection area 1630. The point has the coordinates (px, py). For this example, the point 1920 in the triangle 1910 corresponds to the position of the attribute weight selector 1635 in the selection area 1630 illustrated in the third stage 1680 (i.e., down and towards the right from the center).

For this example, distances d1, d2, and d3 are used to determine the attribute weights for the size attribute, the quality attribute, and the location attribute, respectively. That is, d1 is used to determine the attribute weight for the size attribute, d2 is used to determine the attribute weight for the quality attribute, and d3 is used to determine the attribute weight for the location attribute. Since triangle 1910 is an equilateral triangle, the distances d1, d2, and d3 are related by the following equation (8):

$$d 1 + d 2 + d 3 = \frac{\sqrt{3}}{2} a$$

where d1, d2, and d3 correspond to the distances illustrated in FIG. 19 and a is the length of the sides of the triangle 1910. Based on the coordinate of the point 1920, each of the distances d1, d2, and d3 is calculated using the following equations (9)-(11):

$$d 1 = \frac{\sqrt{3} - 1}{2} a + py$$

$$d 2 = - \frac{\sqrt{3}}{2} px - \frac{1}{2} py + \frac{1}{4} a$$

$$d 3 = \frac{\sqrt{3}}{2} px - \frac{1}{2} py + \frac{1}{4} a$$

In some embodiments, the attribute weight of each attribute is normalized to a common scale. For instance, the attribute weight of each attribute may be normalized to a 0-100 scale by determining a percentage that corresponds to the ratio of (1) the distance (e.g., d1, d2, or d3) that corresponds to the attribute weight to (2) the sum of the distances d1, d2, and d3. The percentages may be calculated using the following equations (12)-(14):

$$Location Percentage = \frac{d 1}{d 1 + d 2 + d 3} \times 100$$

$$Quality Percentage = \frac{d 2}{d 1 + d 2 + d 3} \times 100$$

$$Size Percentage = \frac{d 3}{d 1 + d 2 + d 3} \times 100$$

In some embodiments, the attribute weight of each attribute may be normalized to a 0-1 scale by determining the ratio mentioned above (i.e., the ratio of (1) distance that corresponds to the attribute weight to (2) the sum of the distances). The attribute weights of some embodiments may be expressed as a portion of the specified budget (e.g., the value specified in the UI text input item 1620). For example, if a budget of 1000 is specified and 50 percent is attributed to the quality attribute, 25 percent is attributed to the size attribute, and 25 percent of attributed to the location attribute, the attribute weights are 500 for the quality attribute, 250 for the size attribute, and 250 for the location attribute. Other embodiments may express the attribute weights in any other representation of the attribute weights.

FIGS. 16-18 illustrate a tool for specifying attribute weights for three property attributes that are used to search for properties. Different embodiments use different numbers of property attributes to search for properties. For example, as mentioned above, quality variables can be assigned weights in some embodiments. Thus, in order to allow a user to specify different quality attributes to search for properties, such embodiments may provide a tool for specifying attribute weights for quality variables.

In embodiments that use N property attributes to search for properties where N greater than three, the GUI 1600 of some such embodiments provides an N-side polygon (etc., a square, a pentagon, an octagon, etc.) tool that includes an attribute weight selector for positioning within the polygon (e.g., similar to the tool illustrated in FIGS. 16-18) in order to specify attribute weights for N attributes.

For an N-sided polygon with the center of the circumcircle of the polygon as the origin point, if N is an odd number greater than 3 (5, 7, 9, etc.), the following equations (15)-(17) are used to calculate the coordinates of each of the polygon's vertices and the corresponding endpoints of the side opposite the vertices:

$${x}_{i} = - \frac{a sin ( \frac{2 π}{N} ( i - 1 ) )}{2 sin ( \frac{π}{N} )}$$

$${y}_{i} = \frac{a cos ( \frac{2 π}{N} ( i - 1 ) )}{2 sin ( \frac{π}{N} )}$$

$$k = i + \frac{N - 1}{2}$$

where (xᵢ,yᵢ) are the coordinates of the i^{th} vertex of the polygon and a is the length of each side of the polygon. The endpoints for the side opposite the i^{th} vertex are (xₖ,yₖ) and (xₖ₊₁,yₖ₊₁). For an N-sided polygon with the center of the circumcircle of the polygon as the origin point, N is an even number greater than 3 (4, 6, 8, etc.), the following equations (18)-(20) are used to calculate the coordinates of each of the polygon's vertices and the corresponding endpoints of the side opposite the vertices:

$${x}_{i} = \frac{a cos ( \frac{π}{N} ( 2 i - 1 ) )}{2 sin ( \frac{π}{N} )}$$

$${y}_{i} = \frac{a sin ( \frac{π}{N} ( 2 i - 1 ) )}{2 sin ( \frac{π}{N} )}$$

$$k = i + \frac{N}{2}$$

where (xᵢ,yᵢ) are the coordinates of the i^{th} vertex of the polygon and a is the length of each side of the polygon. The endpoints for the side opposite the i^{th} vertex are the vertices (xₖ,yₖ) and (xₖ₊₁,yₖ₊₁).

The attribute weights for each of the N attributes may be calculated using the following equation (21):

$${d}_{i} = \frac{\vert {A}_{i} {x}_{0} + {B}_{i} {y}_{0} + {C}_{i} \vert}{\sqrt{{A}_{i}^{2} + {B}_{i}^{2}}}$$

$${A}_{i} = {y}_{k + 1} - {y}_{k} , {B}_{i} = {x}_{k} - {x}_{k + 1} , {C}_{i} = {y}_{k} {x}_{k + 1} - {x}_{k} {y}_{k + 1}$$

where (x₀,y₀) is the coordinate value for the point inside the polygon, dᵢ is the distance from the point to the side opposite the i^{th} vertex. To determine the sum of the distances from the point to each vertex in the polygon, the following equation (22) is used:

$${\sum }_{i = 1}^{N} {d}_{i} = \frac{Na}{2} tan ( \frac{π}{2} - \frac{π}{N} )$$

FIG. 20 conceptually illustrates a software architecture of a real estate search engine 2000 of some embodiments. In some embodiments, the real estate search engine 2000 is a module that receives a price and a set of attribute weights, and outputs a ranked set of properties, as illustrated in FIG. 14.

As shown, the real estate search engine 2000 includes a property identifier 2020, an attribute weight processor 2030, and a property-ranking module 2040. In addition, FIG. 20 illustrates a determined real estate data storage 2050 and a processed real estate data storage 2060. In some embodiments, the data storages 2050 and 2060 are implemented as one physical storage. In other embodiments, the determined real estate data and the processed real estate values are stored in separate physical storages. The processed real estate data storage 2060 is similar the processed real estate data storage described above by reference to FIG. 8, in some embodiments. The determined real estate data storage 2050 in some embodiments is similar the determined real estate data storage described above by reference to FIG. 11.

The property identifier 2020 identifies properties based on a price 2005 and a set of attribute weights 2010. In some embodiments, the price 2005 and the set of attribute weights 2010 are similar to the ones described above by reference to FIG. 14. When the property identifier 2020 receives the price 2005 and the set of attribute weights 2010 (e.g., specifying through the GUI 1600), the property identifier 2020 accesses the determined real estate data storage 2050 and the processed real estate data storage 2060 to identify a set of properties based on the price 2005.

In some embodiments, the real estate search engine 2000 identifies a set of properties that have a determined value that is within a defined percentage more or less (e.g., +/−3 percent, +/−6 percent, +/−10 percent, etc.) than the price 2005. In some embodiments, the real estate search engine 2000 identifies a set of properties that have a determined value that is within a defined amount more or less (e.g., +/−$500, +/−$1,000, +/−$10,000, etc.) than the price 2005. Still, in some embodiments, the real estate search engine 2000 uses both of the aforementioned methods, additional methods, or different methods. After the property identifier 2020 identifies a set of properties, the property identifier 2020 sends the price 2005, the attribute weights 2010, and the identified set of properties to the attribute weight processor 2030 for processing.

The attribute weight processor 2030 is responsible for determining attribute weights for each property in the identified set of properties. In different embodiments, the attribute weight processor 2030 uses different methods for determining the attribute weights for the identified set of properties. For instance, the attribute weight processor 2030 of some embodiments identifies the determined attribute values for each of the identified set of properties by accessing the determined real estate data storage 2050 and the processed real estate data storage 2060. The attribute weight processor 2030 of such embodiments uses the determined attribute values of the properties as the properties' attribute weights. In some embodiments, the attribute weight processor 2030 determines attribute weights for each of the identified properties based on the price 2005 and the attribute weights 2010.

FIG. 21 conceptually illustrates a process 2100 of some embodiments for determining attribute weights for properties. In some embodiments, the process 2100 is performed by a real estate search engine, such as the ones described above by reference to FIGS. 14 and 20. For example, the process 2100 in some such embodiments is performed by the attribute weight processor 2030 when the attribute weight processor 2030 receives the price 2005, the attribute weights 2010, and the identified set of properties from the property identifier 2020.

The process 2100 starts by identifying (at 2110) an attribute from the attributes that correspond to the attribute weights of each property. For instance, if the attribute weights of each property include a location weight, a quality weight, and a size weight, the process 2100 identifies a location attribute, a quality attribute, or a size attribute.

Next, the process 2100 sorts (at 2120) the set of properties based on the identified attribute. In some embodiments, the process 2100 sorts the set of properties in ascending order based on the value of the attribute weight of each of the properties in the set of properties that corresponds to the identified attribute. For example, if the quality attribute is the identified attribute, the process 2100 sorts the set of properties in ascending order based on the value of the quality weight of each of the properties in the set of properties.

Before sorting the set of properties, the process 2100 of some embodiments adjusts the properties' attribute weights. For instance, in some embodiments, the process 2100 adjusts the properties' attribute weights based on the price specified for the search query (e.g., the price specified through the GUI 1600). The following equation (23) to adjust each attribute weight of the properties is used in some such embodiments:

$$new attribute weight = \frac{price}{building price} \times current attribute weight$$

where new attribute weight is the value of the adjusted attribute weight, the price is the price 2005, the building price is the price of the building, and current attribute weight is the value of the unadjusted attribute weight. In this manner, the process 2100 (1) reduces the property attribute weights of properties that have a price greater than the price specified for the search query and (2) increases the property attribute weights of properties that have a price less than the price specified for the search query are increased.

The process 2100 then assigns (at 2130) a percentile ranking for the attribute of each property in the set of properties. That is, the process 2100 identifies the distribution of the sorted properties and determines where each property falls within the distribution based on the property's attribute weight. For instance, the process 2100 assigns the property that has the highest attribute weight value with a “100” value and assigns the property that has the lowest attribute weight value with a “1” value.

After assigning percentile rankings to the set of properties, the process 2100 determines (at 2140) whether any attribute is left to process. When the process 2100 determines that there is an attribute left to process, the process 2100 returns to 2110 to continue processing any remaining attributes. Otherwise, the process 2100 proceeds to 2150.

At 2150, the process 2100 calculates the aggregate ranking of each property in the set of properties. The process 2100 of some embodiments calculates the aggregate ranking of each property by adding the assigned percentile rankings together. For instance, if percentile rankings are assigned to a location attribute, a quality attribute, and a size attribute of a property, the process 2100 of such embodiments adds the percentile ranking for the location attribute, the percentile ranking for the quality attribute, and the percentile ranking for the size attribute together to determine the aggregate ranking of the property.

Finally, the process 2100 calculates (at 2160) the attribute weights for each property based on the percentile rankings and the aggregate rankings of the property. In some embodiments, the process 2100 calculates the attribute weights for each property by normalizing the percentile rankings of the attributes of each property to a common scale. For instance, to normalize the percentile rankings of the attributes of each property to a 0-1 scale, the process 2100 of some embodiments divides each percentile ranking for an attribute of a property by the aggregate ranking of the property. Continuing with the example above, the process 2100 calculates the location attribute weight for the property by dividing the percentile ranking for the location attribute of the property by the aggregate ranking of the property. Similarly, the process 2100 calculates the quality attribute weight for the property by dividing percentile ranking for the quality attribute of the property by the aggregate ranking of the property and calculates the size attribute weight for the property by dividing the percentile ranking for the size attribute of the property by the aggregate ranking of the property.

Returning to FIG. 20, the property-ranking module 2040 ranks the identified set of properties based on the determined attribute weights of the properties and the attribute weights 2010. The property-ranking module 2040 of different embodiments uses different methods to rank the set of properties. For instance, the property-ranking module 2040 of some embodiments uses the following equation (24) to determine a “distance measure” between the attribute weights 2010 that includes a location weight, a quality weight, and a size weight, and the corresponding determined attribute weights of a property:

$$Distance Measure = {( \frac{lw}{dlw} )}^{lw} \times {( \frac{sw}{dsw} )}^{sw} \times {( \frac{qw}{dqw} )}^{qw}$$

where distance measure is the “distance measure” of a property, lw is the location weight of the requested attribute weights 2010, dlw is the determined location weight of the property, sw is the requested size weight of the attribute weights 2010, dsw is the determined size weight of the property, qw is the requested quality weight of the attribute weights 2010, and dqw is the determined quality weight of the property. The property-ranking module 2040 then ranks the properties in descending order based on the “distance measure” values. Properties with a lower calculated “distance measure” between the requested attribute weights and the determined attribute weights from the aforementioned real estate value models are ranked higher and properties with a higher calculated “distance measure” are ranked lower.

As another example, the property-ranking module 2040 of some embodiments uses the following equation (25) to determine a “error” between the requested attribute weights 2010 that includes a location weight, a quality weight, and a size weight, and the corresponding determined attribute weights of a property:

error=|lw−dlw|+|sw−dsw|+|qw−dqw|

where error is the “error” of a property, lw is the requested location weight of the attribute weights 2010, dlw is the determined location weight of the property, sw is the requested size weight of the attribute weights 2010, dsw is the determined size weight of the property, qw is the requested quality weight of the attribute weights 2010, and dqw is the determined quality weight of the property. After determining the “error” values of the properties, the property-ranking module 2040 ranks the properties in descending order based on the “error” values. Properties with a lower calculated “error” are ranked higher and properties with a higher calculated “error” are ranked lower.

Several techniques for ranking properties are described above. Additional and other techniques may be used in some embodiments. For instance, the property-ranking module 2040 of some embodiments might calculate an “error” using the sum of the squares of each of the differences between the attribute weights.

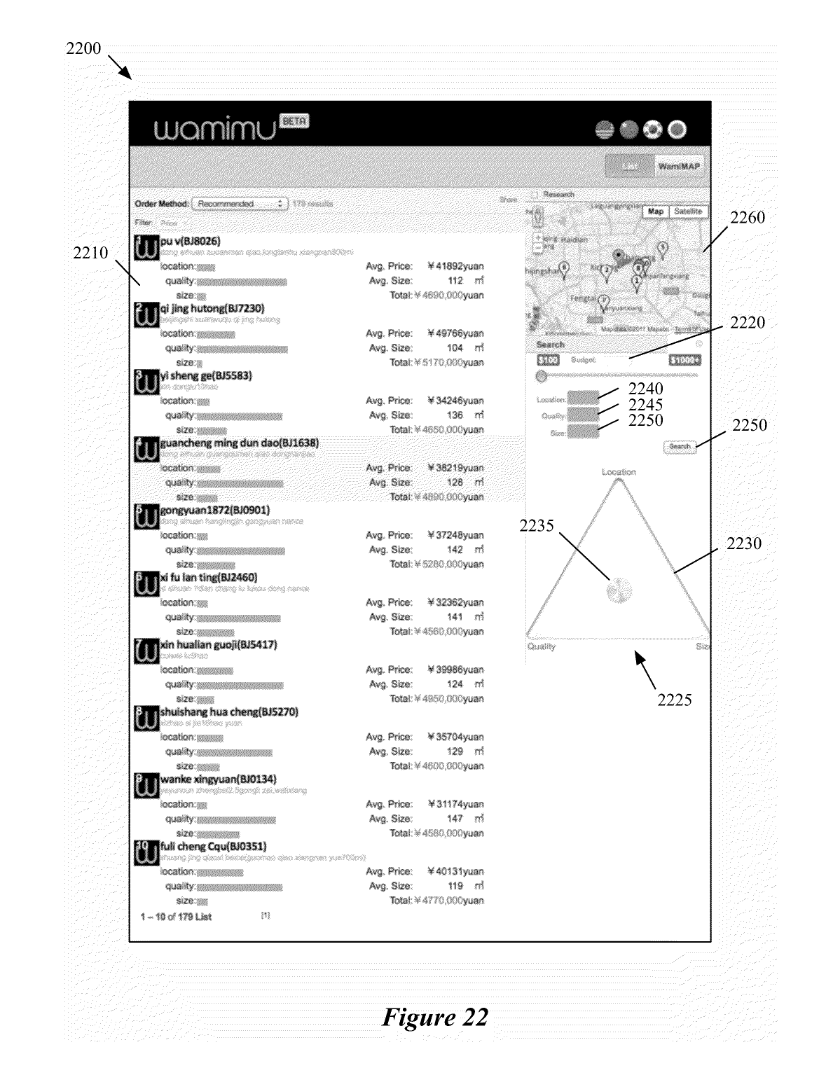

FIG. 22 conceptually illustrates an example GUI 2200 that shows results of a real estate search query. In particular, FIG. 22 illustrates an example set of results of properties based on a search query that specifies properties for sale, a requested price of 5 million yuan, and properties with a high quality attribute and low size and location attributes (e.g., using the GUI 1600 illustrated in FIGS. 16-18).

In some embodiments, the GUI 2200 is displayed when the selectable UI item 1655 is selected (e.g., through a cursor control operation such as clicking a mouse button, tapping a trackpad, or touching a touchscreen). The GUI 2200 of some embodiments is displayed in a display area separate from the GUI 2200. However, in some embodiments, the GUI 2200 is displayed (instead of the GUI 1600) in the display area that is used to display the GUI 1600.

As shown, the GUI 2200 includes the set of properties 2210, an adjustable attribute weight selection control 2225 that includes a selection area 2230 and an attribute weight selector 2235, a set of attribute weight indicators 2240-2250, selectable UI item 2250, and a map display area 2260.

In this example, the adjustable attribute weight selection control 2225, the set of attribute weight indicators 2240-2250, and the selectable UI item 2250 are similar to the adjustable attribute weight selection control 1625, the set of attribute weight indicators 1640-1650, and the selectable UI item 1655 described above by reference to FIG. 16. As shown, the GUI 2200 displays the attribute weight selection control 2225 with the attribute weight selector 2235 positioned in a default location similar to the default attribute weight selector 1635 in FIG. 16. In some embodiments, the GUI 2200 displays the attribute weight selector 2235 in the position that was specified for the search query that generated the example set of results of properties.

The map display area 2260 displays a map of the area that includes the properties in the set of properties 2210. In this example, the map display area 2260 displays a street map of the area that includes the properties in the set of properties 2210. Other types of maps may be displayed in the map display area 2260 in some embodiments.

As shown, the set of properties 2210 includes the 10 highest ranked properties out of 179 properties that resulted from the search. In some embodiments, the set of properties 2210 includes a defined number (e.g., 10, 20, 25, 50, 100, etc.) of the highest ranked properties. In other embodiments, the set of properties 2210 includes a defined percentage (e.g., 5 percent, 10 percent, 20 percent, etc.) of the highest ranked properties. In this example, these search results correspond to requested weight attributes that weighs more quality and less of location and size.

### IV. Example Real Estate Search System

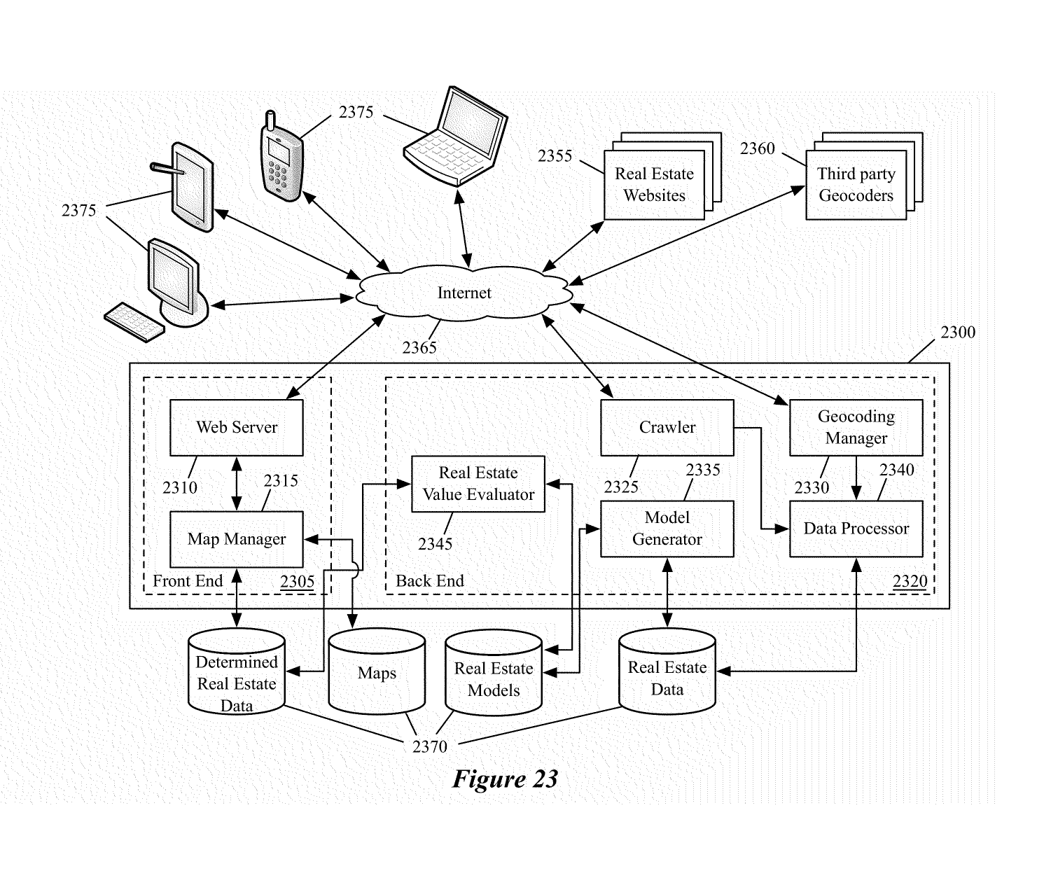

FIG. 23 conceptually illustrates a software architecture of a real estate search system 2300 of some embodiments. As shown, the real estate search system 2300 includes a front end 2305 and a back end 2320. FIG. 23 also illustrates data storages 2370, devices 2375, the Internet 2365, real estate websites 2355, and third party geocoders 2360. In some embodiments, the data storages 2370 are implemented as one physical storage. In other embodiments, the data storages 2370 are implemented as separate storages. Still, in some embodiments, some of the data storages 230 are implemented as one physical storage and some of the data storages are implemented as separate storages. In some embodiments, the front 2305 and the back end 2320 are implemented on the same set of computing devices (e.g. servers, desktop computers, etc.) while, in other embodiments, the front 2305 and the back end 2320 are implemented on the separate sets of computing devices.

The back end 2320 of the system 2300 handles the different aspects of the data processing of the system 2300. As shown, the back end 2320 includes a crawler 2325, a geocoding manager 2330, a model generator 2335, a data processor 2340, and a real estate value evaluator 2345.

The crawler 2325 is a tool for crawling sources of data to retrieve data from the sources of data. In this example, the crawler 2325 crawls real estate websites 2355 through the Internet 2365. The real estate websites 2355 include real estate websites, public real estate records websites, sale and/or rental listings website, or any other websites that have real estate data or data related to real estate. In some embodiments, the crawler 2325 uses any of the numerous third party crawling tools to crawl the Internet 2365 for real estate data contained in the real estate websites 2355. The crawler 2355 of some embodiments crawls a defined list of websites. In some embodiments, the crawler 2355 passes the real estate data obtained from the real estate websites 2355 to the data processor 2340. In other embodiments, the crawler 2355 stores the real estate data in the real estate data storage for later processing by the data processor 2340.

The geocoding manager 2330 determines the location of real estate by using the third party geocoders 2360 through the Internet 2365. The third part geocoders 2360 may be a website, a web-based service, an API, etc. When the geocoding manager 2330 determines the location of real estate, the geocoding manager 2330 of some embodiments sends the data to the data processor 2340. In some embodiments, the geocoding manager 2330 stores the data in the real estate data storage for later processing by the data processor 2340.

The data processor 2340 processes the real estate data retrieved by the crawler 2325 and the location data obtained by the geocoding manager 2330. In some embodiments, the data processor 2340 is implemented as any of the real estate data processors described above by reference to FIGS. 1, 3, and 4. Once the data processor 2340 processes the real estate data, the data processor 2340 stores the data in the real estate data storage.

The model generator 2335 generates real estate models based on the real estate data processed by the data processor 2340. The model generator 2335 retrieves the processed data from the real estate data storage to generate real estate models. The model generator 2335 stores the generated real estate models in the real estate models storage. In some embodiments, the model generator 2335 is implemented as any of the real estate modelers described above by reference to FIGS. 1, 7, and 8.

The real estate value evaluator 2345 uses the real estate models generated by the model generator 2335 to determine values of properties. In some embodiments, the real estate value evaluator 2345 retrieves the real estate models that will be used to determine values of properties from the real estate models storage. The real estate value evaluator 2345 of some embodiments stores the determined values in the determined real estate data storage. In some embodiments, the model generator 2335 is implemented as any of the real estate value evaluators described above by reference to FIGS. 1, 10, and 11.

The front end 2305 of the system 2300 is responsible for facilitating the search for properties based on the determined values of properties determined by the back end 2320. As shown, the front end 2305 includes a web server 2310 and a map manager 2315.

The web server 2310 allows the devices 2375 to search for properties through the Internet 2365. The web server 2310 may provide the search function through a webpage (e.g., such as the GUI 1600), a web service, an application programming interface (API), etc. The web server 2310 additionally processes the search queries that the web server 2310 receives from the devices 2375 through the Internet 2365. In some embodiments, a portion of the web server 2310 is implemented as any of the real estate search engine described above by reference to FIGS. 14 and 20.

The map manager 2315 manages the maps for display in GUIs, such as the GUI 2200 illustrated in FIG. 22. In some embodiments, the map manager 2315 retrieves the map that corresponds to the area in which the properties of the search results are located from the maps storage and passes the map to the web server 2310 for the web server 2310 to provide to the devices 2375 for display on the devices 2375.

While many of the features have been described as being performed by one module (e.g., the web server 2310), one of ordinary skill in the art will recognize that the functions described herein might be split up into multiple modules. Similarly, functions described as being performed by multiple different modules might be performed by a single module in some embodiments (e.g., the web server 2310 and the map manager 2315).

### V. Electronic System

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

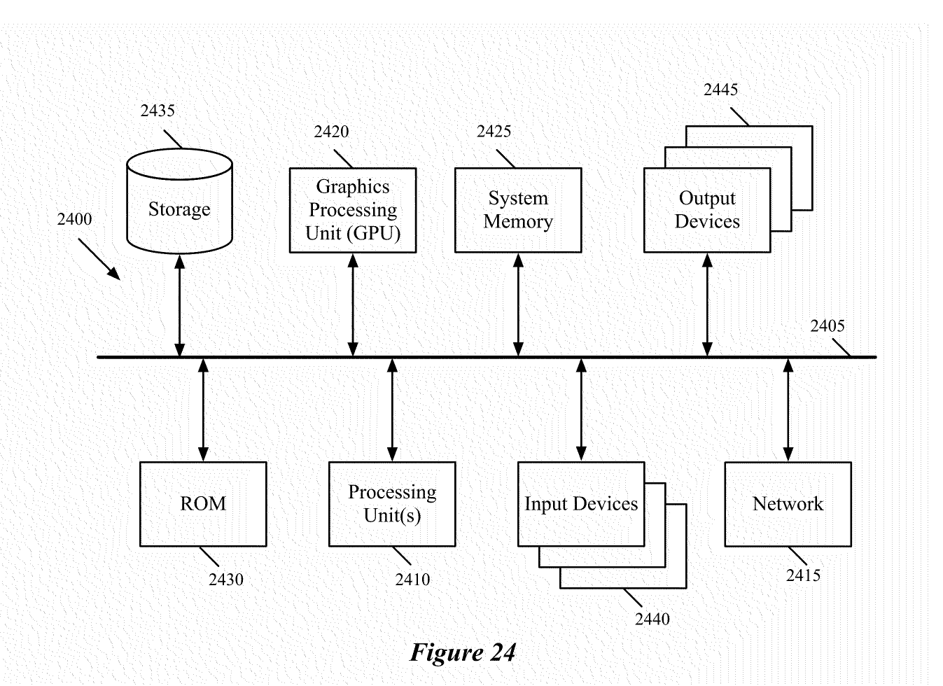

FIG. 24 conceptually illustrates an electronic system 2400 with which some embodiments of the invention are implemented. The electronic system 2400 may be a computer, phone, PDA, or any other sort of electronic device. Such an electronic system includes various types of computer readable media and interfaces for various other types of computer readable media. Electronic system 2400 includes a bus 2405, processing unit(s) 2410, a graphics processing unit (GPU) 2420, a system memory 2425, a read-only memory 2430, a permanent storage device 2435, input devices 2440, and output devices 2445.

The bus 2405 collectively represents all system, peripheral, and chipset buses that communicatively connect the numerous internal devices of the electronic system 2400. For instance, the bus 2405 communicatively connects the processing unit(s) 2410 with the read-only memory 2430, the GPU 2420, the system memory 2425, and the permanent storage device 2435.

From these various memory units, the processing unit(s) 2410 retrieve instructions to execute and data to process in order to execute the processes of the invention. The processing unit(s) may be a single processor or a multi-core processor in different embodiments. Some instructions are passed to and executed by the GPU 2420. The GPU 2420 can offload various computations or complement the image processing provided by the processing unit(s) 2410.

The read-only-memory (ROM) 2430 stores static data and instructions that are needed by the processing unit(s) 2410 and other modules of the electronic system. The permanent storage device 2435, on the other hand, is a read-and-write memory device. This device is a non-volatile memory unit that stores instructions and data even when the electronic system 2400 is off. Some embodiments of the invention use a mass-storage device (such as a magnetic or optical disk and its corresponding disk drive) as the permanent storage device 2435.

Other embodiments use a removable storage device (such as a floppy disk, flash drive, or ZIP® disk, and its corresponding disk drive) as the permanent storage device. Like the permanent storage device 2435, the system memory 2425 is a read-and-write memory device. However, unlike storage device 2435, the system memory is a volatile read-and-write memory, such a random access memory. The system memory stores some of the instructions and data that the processor needs at runtime. In some embodiments, the invention's processes are stored in the system memory 2425, the permanent storage device 2435, and/or the read-only memory 2430. For example, the various memory units include instructions for processing multimedia clips in accordance with some embodiments. From these various memory units, the processing unit(s) 2410 retrieve instructions to execute and data to process in order to execute the processes of some embodiments.

The bus 2405 also connects to the input and output devices 2440 and 2445. The input devices enable the user to communicate information and select commands to the electronic system. The input devices 2440 include alphanumeric keyboards and pointing devices (also called “cursor control devices”). The output devices 2445 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 24, bus 2405 also couples electronic system 2400 to a network 2415 through a network adapter (not shown). In this manner, the computer can be a part of a network of computers (such as a local area network (“LAN”), a wide area network (“WAN”), or an Intranet, or a network of networks, such as the Internet. Any or all components of electronic system 2400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (including FIGS. 2, 5, 9, 12, 15, and 21) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

We claim:

1. A method of providing a graphical user interface (GUI), the method comprising:
providing a first user interface (UI) element for receiving a value that represents a budget price for a search of properties; and
providing a two-dimensional shape comprising a plurality of locations representing a plurality of property attributes, wherein each of at least two locations is associated with only one attribute and a remaining plurality of locations are associated with more than one attribute;
providing an indicator that is moveable within the two-dimensional shape for indicating a particular location within the two-dimensional shape, the particular location for identifying a plurality of values that correlate the budget price to the plurality of attributes; and
providing a second UI element that, when selected, initiates a search for properties based on the received value and the plurality of values specified through the indicator.

2. The method of claim 1 further comprising providing a set of UI elements for graphically representing in real-time the set of values for the set of property attributes that correspond to the location of the indicator within the two-dimensional shape.

3. The method of claim 1, wherein the set of property attributes comprises a location attribute.

4. The method of claim 1, wherein the set of property attributes comprises a size attribute.

5. The method of claim 1, wherein the set of property attributes comprises a quality attribute.

6. The method of claim 1 further comprising a third UI element for indicating a type of property to search.

7. The method of claim 1 further comprising providing a display area for displaying the set of properties.

8. The method of claim 7, wherein the display area is provided in response to the selection of the second UI element.

9. The method of claim 7 further comprising providing a map that indicates on the map the location of each property in the set of properties.

10. The method of claim 9, wherein the display area is further for displaying the map.

11. A computer readable medium storing a computer program which when executed by at least one processing unit provides a graphical user interface (GUI), the GUI comprising:
a first user interface (UI) element for receiving a value that represents a budget price; and
a two-dimensional shape comprising a plurality of locations representing a plurality of property attributes, wherein each of at least two locations is associated with only one attribute and a remaining plurality of locations are associated with more than one attribute;
an indicator that is moveable within the two-dimensional shape for indicating a particular location within the two-dimensional shape, the particular location for identifying a plurality of values that correlate the budget price to the plurality of attributes; and
a second UI element for that, when selected, initiates a search for properties based on the received value and the plurality of values specified through the indicator.

12. The computer readable medium of claim 11, wherein the GUI further comprises a set of UI elements for graphically representing in real-time the set of values for the set of property attributes that correspond to the location of the indicator within the two-dimensional shape.

13. The computer readable medium of claim 11, wherein the set of property attributes comprises a location attribute.

14. The computer readable medium of claim 11, wherein the set of property attributes comprises a size attribute.

15. The computer readable medium of claim 11, wherein the set of property attributes comprises a quality attribute.

16. The computer readable medium of claim 11, wherein the GUI further comprises a third UI element for indicating a type of property to search.

17. The method of claim 16, wherein the type of property to search is property for rent.

18. The method of claim 16, wherein the type of property to search is property for sale.

19. The method of claim 11, wherein the GUI further comprises a map that indicates on the map the location of each property in the set of properties.

20. The method of claim 19, the map is displayed in response to the selection of the second UI element.
